(19) United States
(12) Patent Application Publication
(10) Pub. No.: US 2023/0316242 A1
(43) Pub. Date: Oct. 5, 2023

(54) USER INTERFACES FOR INITIATING TRANSACTIONS

(71) Applicant: Apple Inc., Cupertino, CA (US)

(72) Inventor: Lori CHOY, San Jose, CA (US)

(21) Appl. No.: 18/131,027

(22) Filed: Apr. 5, 2023

Related U.S. Application Data
(60) Provisional application No. 63/349,074, filed on Jun. 4, 2022.
(60) Provisional application No. 63/327,751, filed on Apr. 5, 2022.

(51) Int. Cl. G06Q 20/10; G06F 3/0482

(52) U.S. Cl. CPC G06Q 20/10; G06F 3/0482

(57) ABSTRACT

The present disclosure relates to interfaces for initiating transactions. An example method includes concurrently displaying a first visual representation corresponding to a first asset account and a second visual representation corresponding to a second asset account; while concurrently displaying the first and second visual representations, receiving selection of the first visual representation; in response to receiving selection of the first visual representation, displaying an option to initiate a transfer request using the first asset account; while displaying the option to initiate a transfer using the first asset account, receiving selection of the option; in response to receiving selection of the option, displaying representations of one or more users; and while displaying the representations of the one or more users, receiving selection of a first representation corresponding to a first user of the one or more users as a recipient of the transfer request using the first asset account.

### CROSS-REFERENCE TO RELATED APPLICATIONS

This application claims priority to U.S. Provisional Patent Application Ser. No. 63/327,751, filed on Apr. 5, 2022, entitled “USER INTERFACES FOR INITIATING TRANSACTIONS” and to U.S. Provisional Patent Application Ser. No. 63/349,074, filed on Jun. 4, 2022, entitled “USER INTERFACES FOR INITIATING TRANSACTIONS”. The contents of each of these applications are incorporated herein by reference in their entirety.

### FIELD

The present disclosure relates generally to computer user interfaces, and more specifically to techniques for initiating transactions.

### BACKGROUND

Initiating transactions, such as transfers of resources, using electronic devices provides a convenient and efficient method of initiating the exchange of resources between accounts. In particular, initiating transactions in this manner enables a user to, using an electronic device, quickly and easily request a transfer of resources to or from an account of the user.

### BRIEF SUMMARY

Some techniques for initiating transactions using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for initiating transactions. Such methods and interfaces optionally complement or replace other methods for initiating transactions. Such methods and interfaces reduce the cognitive burden on a user and produce a more efficient human-machine interface. For battery-operated computing devices, such methods and interfaces conserve power and increase the time between battery charges.

Example methods are described herein. An example method includes, at a computer system that is in communication with a display generation component and one or more input devices: concurrently displaying, via the display generation component, a portion of a first visual representation corresponding to a first asset account and a portion of a second visual representation, different from the first visual representation, corresponding to a second asset account that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account, displaying, via the display generation component, an option to initiate a transfer request using the first asset account; while displaying the option to initiate a transfer request using the first asset account, receiving, via the one or more input devices, selection of the option to initiate a transfer request using the first asset account; in response to receiving selection of the option to initiate a transfer request using the first asset account, displaying, via the display generation component, representations of one or more users; and while displaying the representations of the one or more users, receiving, via the one or more input devices, selection of a first representation corresponding to a first user of the one or more users as a recipient of the transfer request using the first asset account.

Example non-transitory computer-readable storage media are described herein. An example non-transitory computer-readable storage medium stores one or more programs configured to be executed by one or more processors of a computer system that is in communication with a display generation component and one or more input devices and includes instructions for: concurrently displaying, via the display generation component, a portion of a first visual representation corresponding to a first asset account and a portion of a second visual representation, different from the first visual representation, corresponding to a second asset account that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account, displaying, via the display generation component, an option to initiate a transfer request using the first asset account; while displaying the option to initiate a transfer request using the first asset account, receiving, via the one or more input devices, selection of the option to initiate a transfer request using the first asset account; in response to receiving selection of the option to initiate a transfer request using the first asset account, displaying, via the display generation component, representations of one or more users; and while displaying the representations of the one or more users, receiving, via the one or more input devices, selection of a first representation corresponding to a first user of the one or more users as a recipient of the transfer request using the first asset account.

Example transitory computer-readable storage media are described herein. An example non-transitory computer-readable storage medium stores one or more programs configured to be executed by one or more processors of a computer system that is in communication with a display generation component and one or more input devices and includes instructions for: concurrently displaying, via the display generation component, a portion of a first visual representation corresponding to a first asset account and a portion of a second visual representation, different from the first visual representation, corresponding to a second asset account that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account, displaying, via the display generation component, an option to initiate a transfer request using the first asset account; while displaying the option to initiate a transfer request using the first asset account, receiving, via the one or more input devices, selection of the option to initiate a transfer request using the first asset account; in response to receiving selection of the option to initiate a transfer request using the first asset account, displaying, via the display generation component, representations of one or more users; and while displaying the representations of the one or more users, receiving, via the one or more input devices, selection of a first representation corresponding to a first user of the one or more users as a recipient of the transfer request using the first asset account.

Example computer systems are described herein. An example computer system is configured to communicate with a display generation component and one or more input devices, comprising: one or more processors; and memory storing one or more programs configured to be executed by the one or more processors, the one or more programs including instructions for: concurrently displaying, via the display generation component, a portion of a first visual representation corresponding to a first asset account and a portion of a second visual representation, different from the first visual representation, corresponding to a second asset account that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account, displaying, via the display generation component, an option to initiate a transfer request using the first asset account; while displaying the option to initiate a transfer request using the first asset account, receiving, via the one or more input devices, selection of the option to initiate a transfer request using the first asset account; in response to receiving selection of the option to initiate a transfer request using the first asset account, displaying, via the display generation component, representations of one or more users; and while displaying the representations of the one or more users, receiving, via the one or more input devices, selection of a first representation corresponding to a first user of the one or more users as a recipient of the transfer request using the first asset account.

An example computer system is configured to communicate with a display generation component and one or more input devices and includes means for concurrently displaying, via the display generation component, a portion of a first visual representation corresponding to a first asset account and a portion of a second visual representation, different from the first visual representation, corresponding to a second asset account that is different from the first asset account; means for, while concurrently displaying the portion of the first visual representation and the portion of the second visual representation, receiving, via the one or more input devices, selection of the first visual representation corresponding to the first asset account; means for, in response to receiving selection of the first visual representation corresponding to the first asset account, displaying, via the display generation component, an option to initiate a transfer request using the first asset account; means for, while displaying the option to initiate a transfer request using the first asset account, receiving, via the one or more input devices, selection of the option to initiate a transfer request using the first asset account; means for, in response to receiving selection of the option to initiate a transfer request using the first asset account, displaying, via the display generation component, representations of one or more users; and while displaying the representations of the one or more users, receiving, via the one or more input devices, selection of a first representation corresponding to a first user of the one or more users as a recipient of the transfer request using the first asset account.

Example computer program products are described herein. An example computer program product includes one or more programs configured to be executed by one or more processors of a computer system that is in communication with a display generation component and one or more input devices, the one or more programs including instructions for: concurrently displaying, via the display generation component, a portion of a first visual representation corresponding to a first asset account and a portion of a second visual representation, different from the first visual representation, corresponding to a second asset account that is different from the first asset account; while concurrently displaying the portion of the first visual representation and the portion of the second visual representation, receiving, via the one or more input devices, selection of the first visual representation corresponding to the first asset account; in response to receiving selection of the first visual representation corresponding to the first asset account, displaying, via the display generation component, an option to initiate a transfer request using the first asset account; while displaying the option to initiate a transfer request using the first asset account, receiving, via the one or more input devices, selection of the option to initiate a transfer request using the first asset account; in response to receiving selection of the option to initiate a transfer request using the first asset account, displaying, via the display generation component, representations of one or more users; and while displaying the representations of the one or more users, receiving, via the one or more input devices, selection of a first representation corresponding to a first user of the one or more users as a recipient of the transfer request using the first asset account.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for initiating transactions, thereby increasing the effectiveness, efficiency, and user satisfaction with such devices. Such methods and interfaces may complement or replace other methods for initiating transactions.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3 is a block diagram of an exemplary multifunction device with a display and a touch-sensitive surface in accordance with some embodiments.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 6 illustrates exemplary devices connected via one or more communication channels, in accordance with some embodiments.

FIGS. 7A-7I illustrate exemplary user interfaces for initiating a transaction for remote data storage associated with a user account, in accordance with some embodiments.

FIGS. 8A-8AE illustrate exemplary user interfaces for initiating a transaction for a user account, in accordance with some embodiments.

FIG. 9 is a flow diagram illustrating a method for initiating a transaction in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for initiating transactions. Such techniques can reduce the cognitive burden on a user who initiates transactions, thereby enhancing productivity. Further, such techniques can reduce processor and battery power otherwise wasted on redundant user inputs.

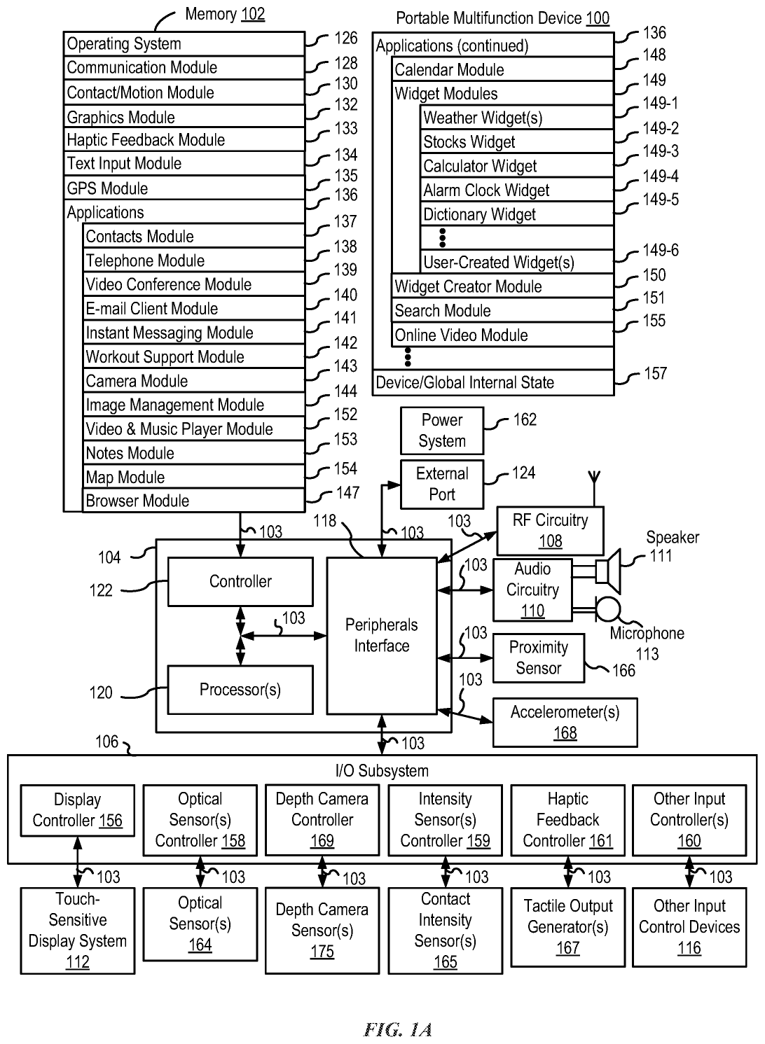

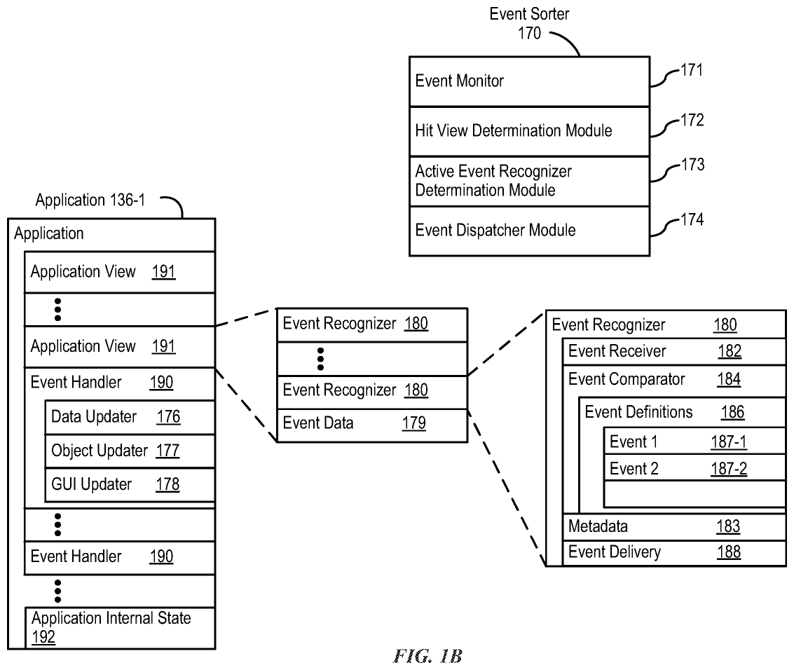

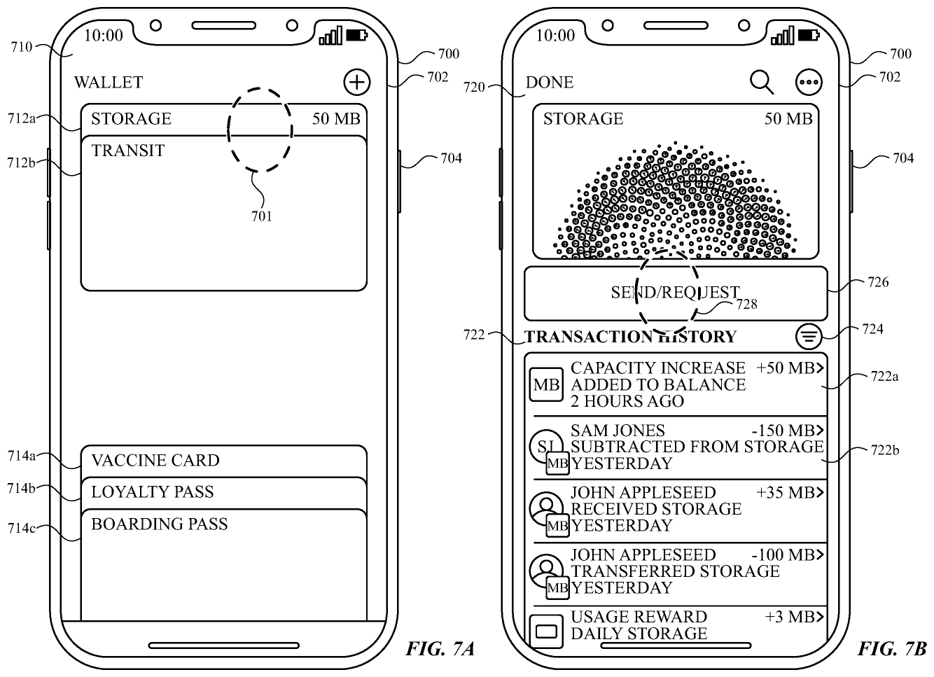

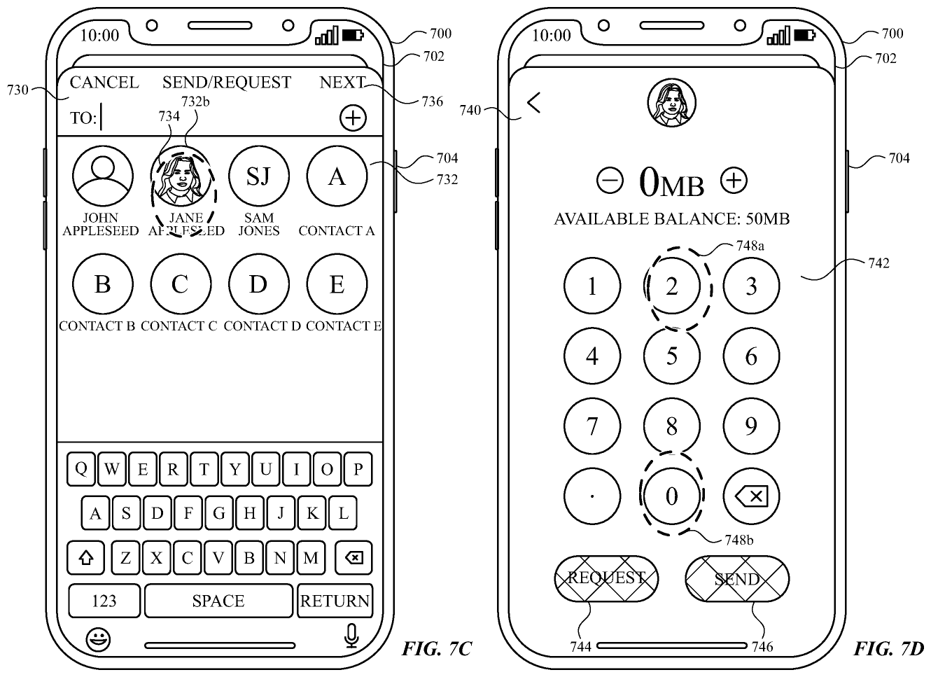

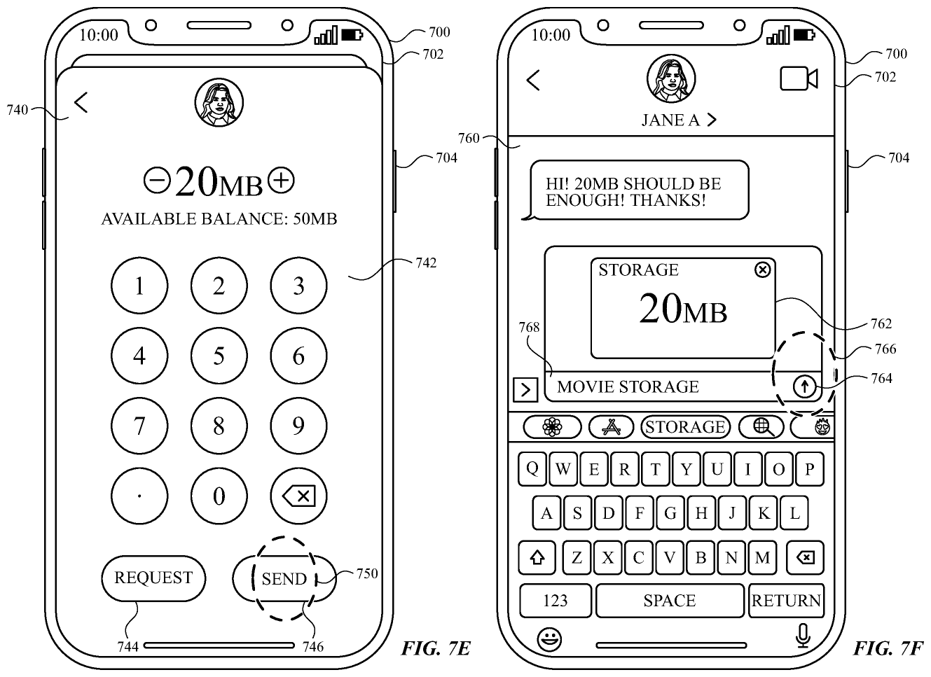

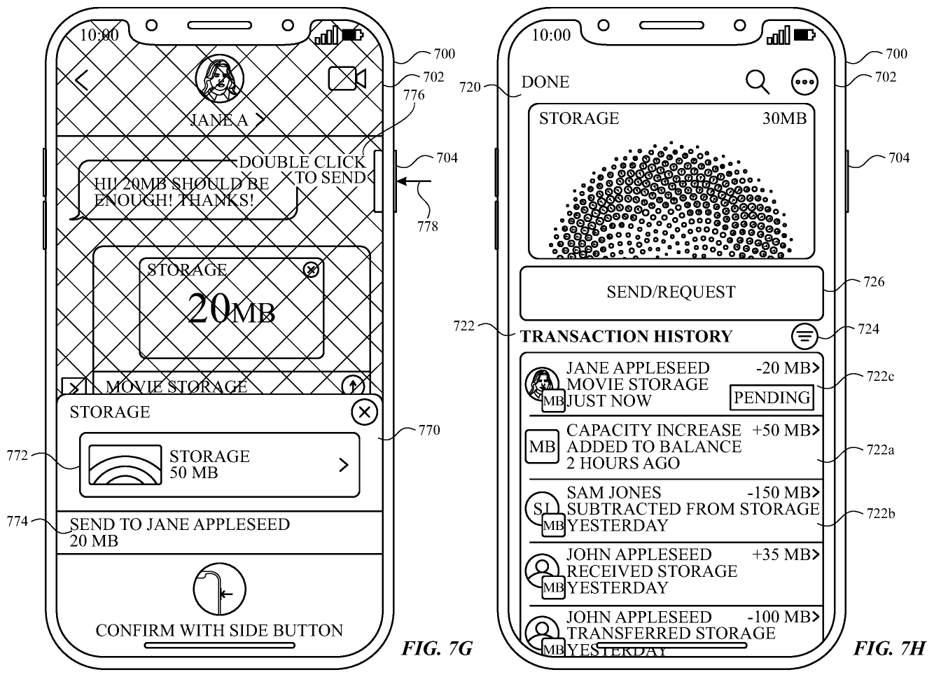

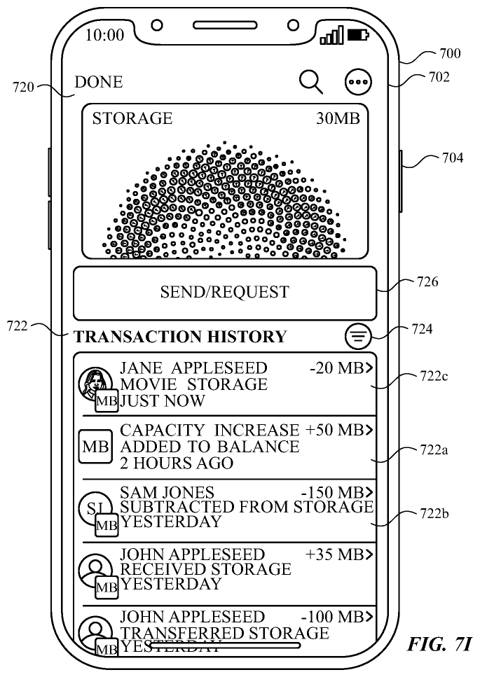

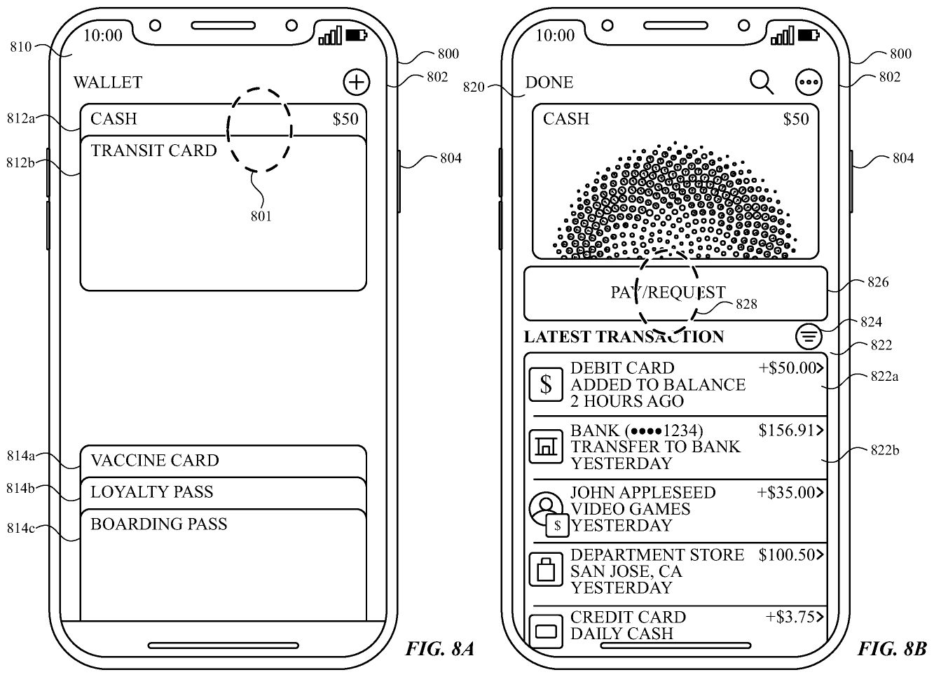

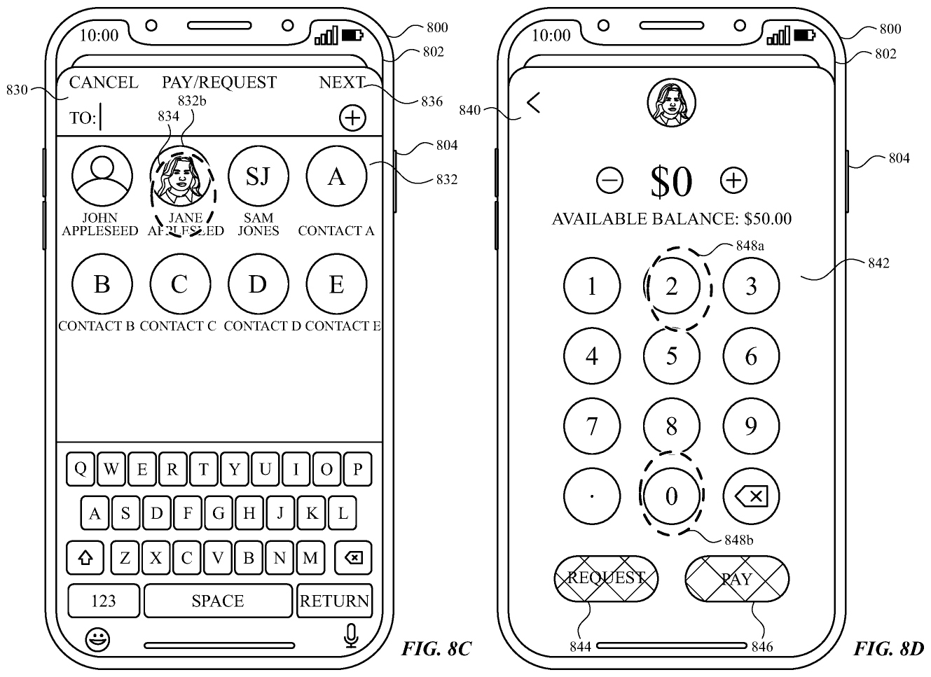

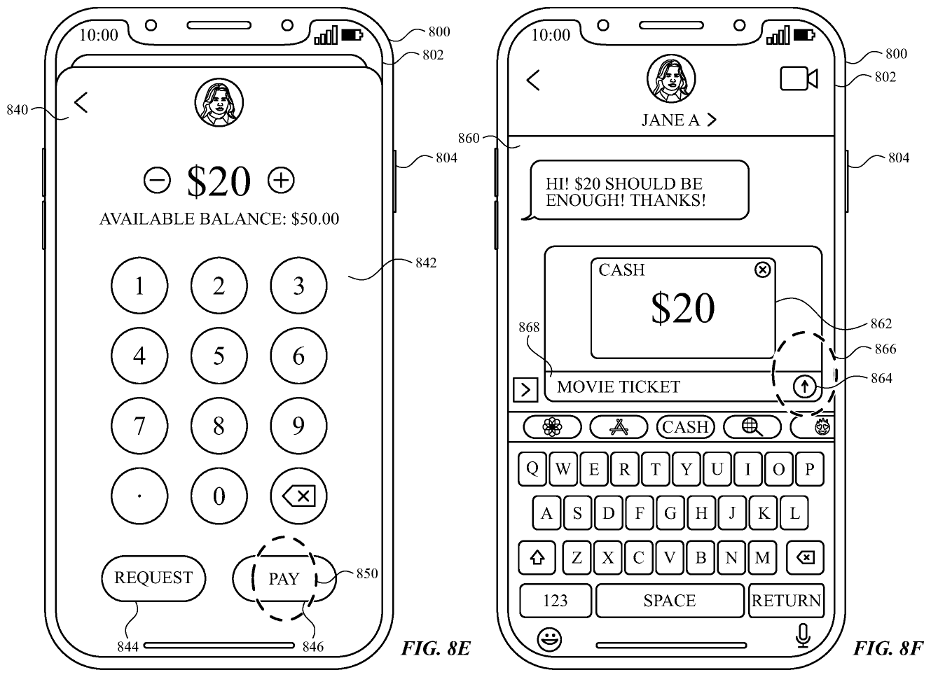

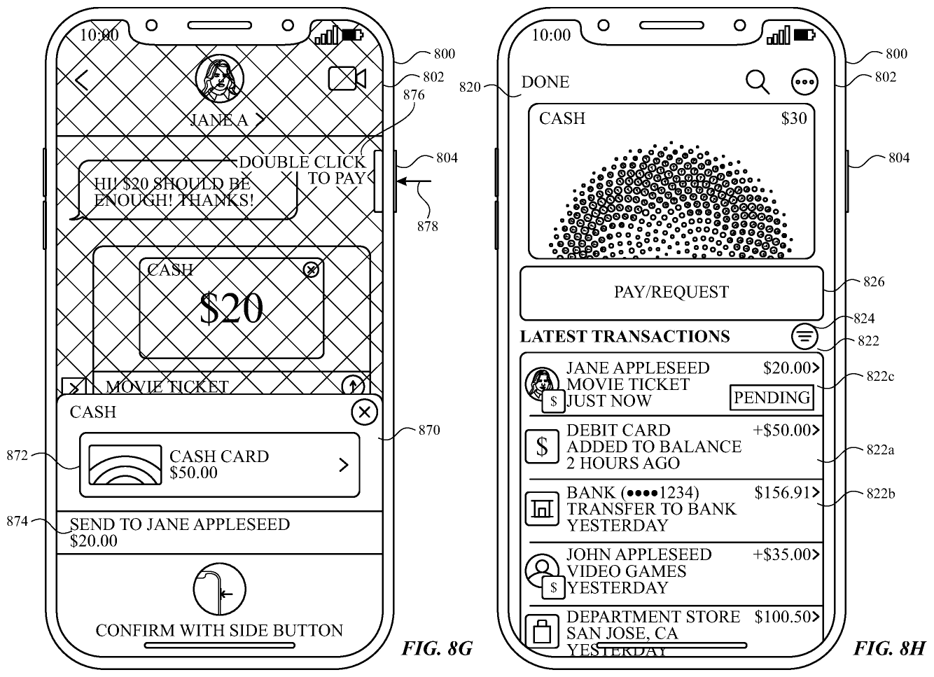

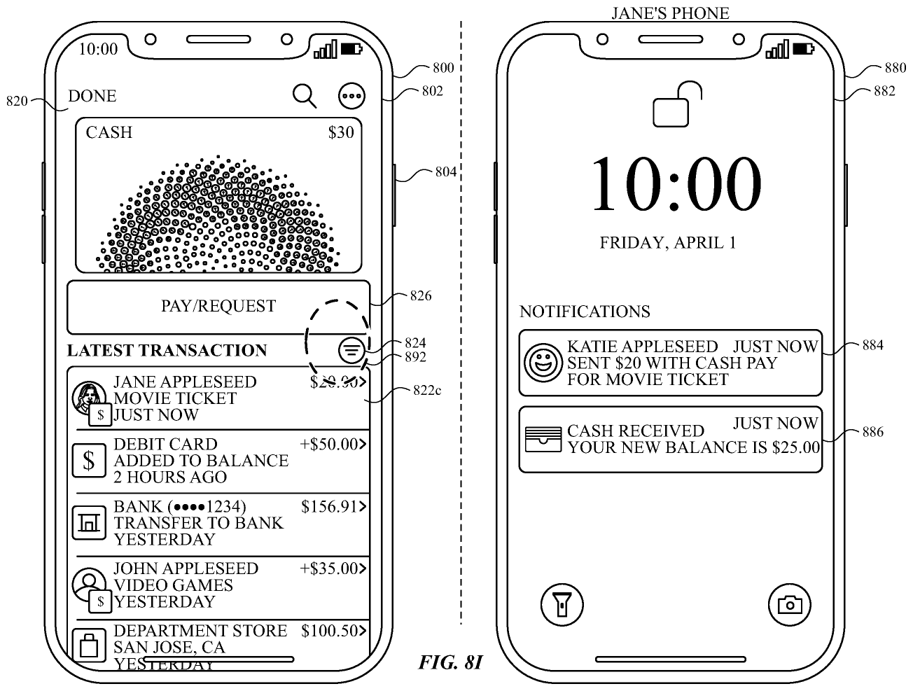

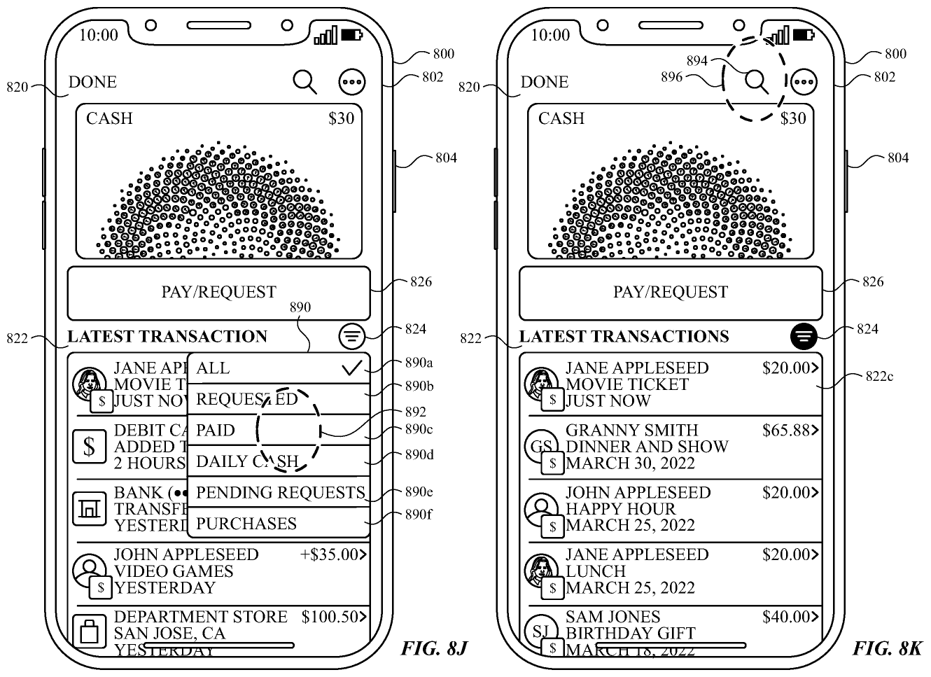

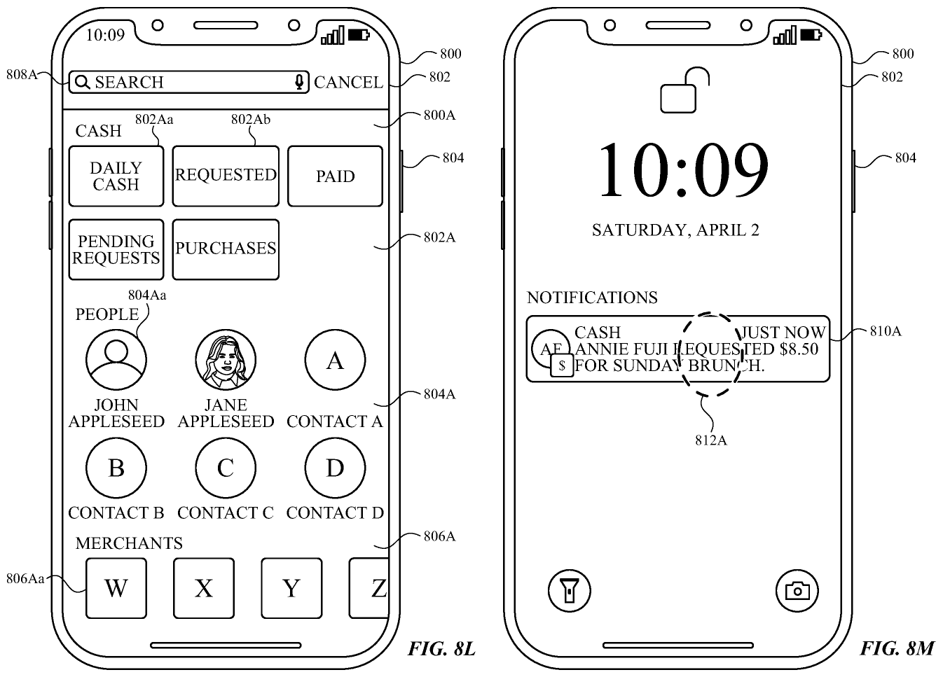

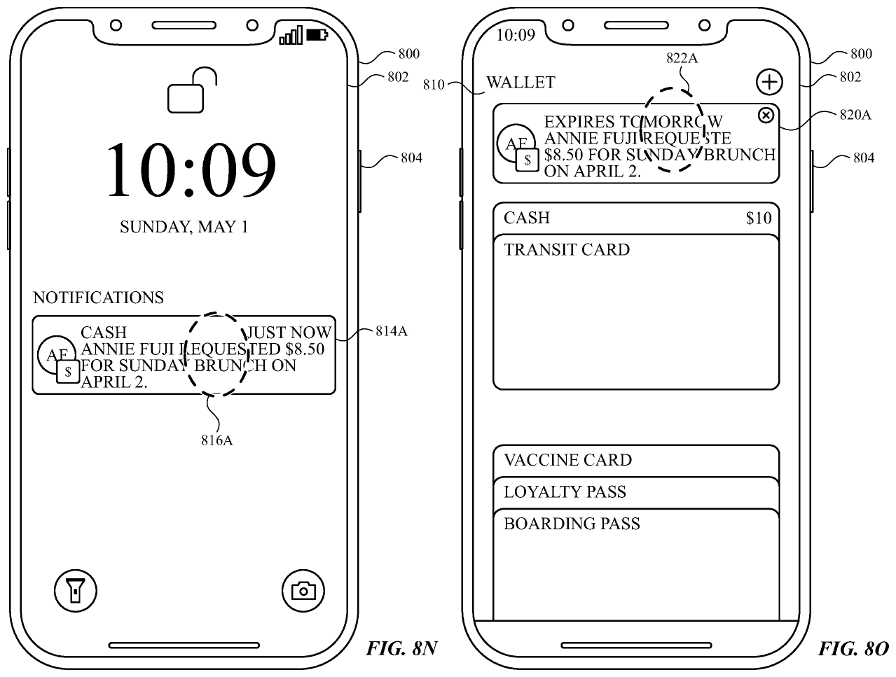

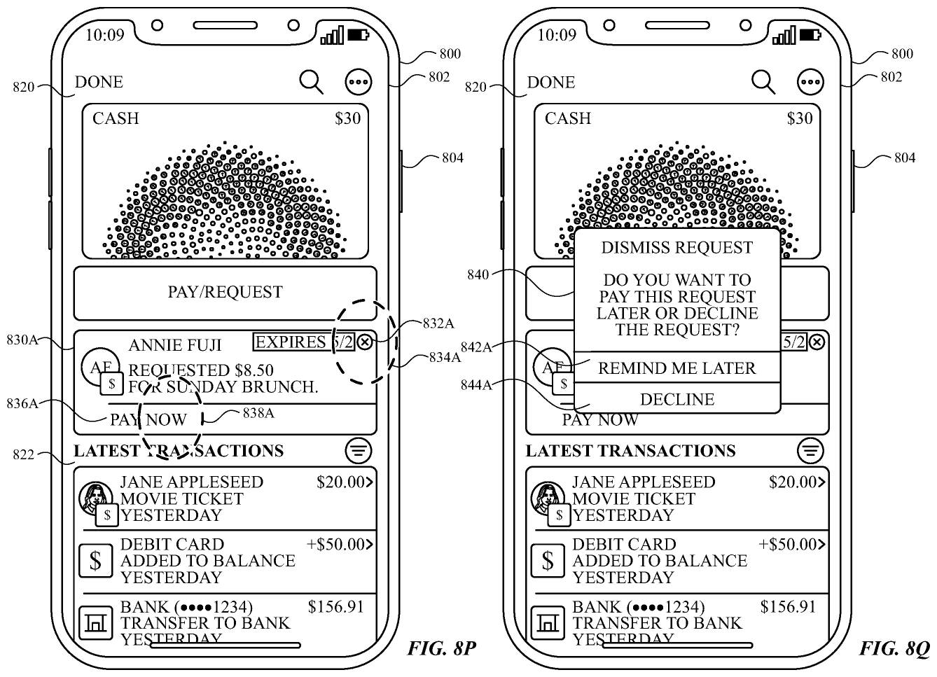

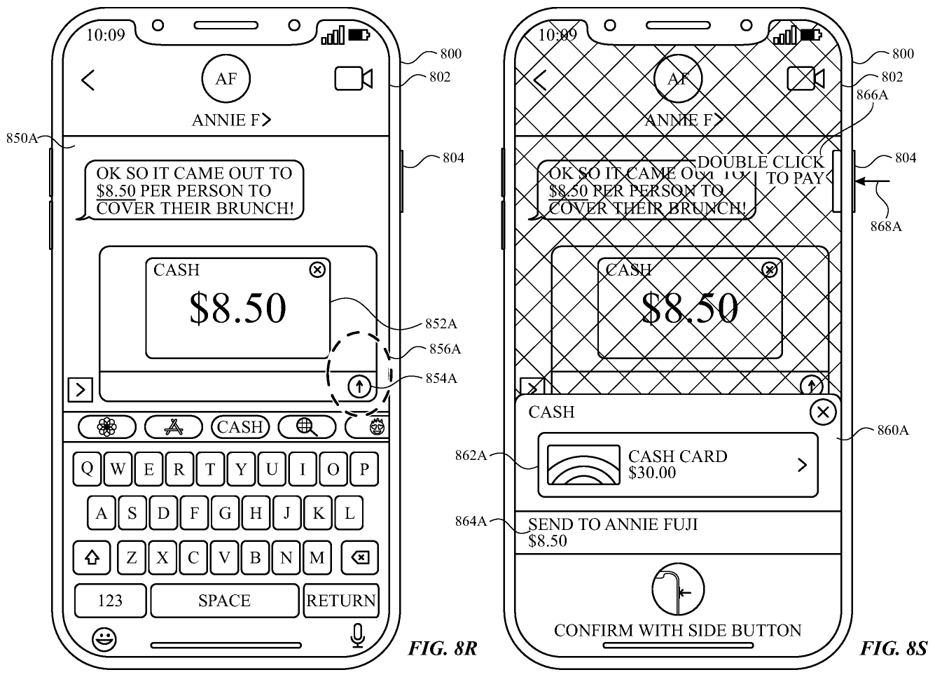

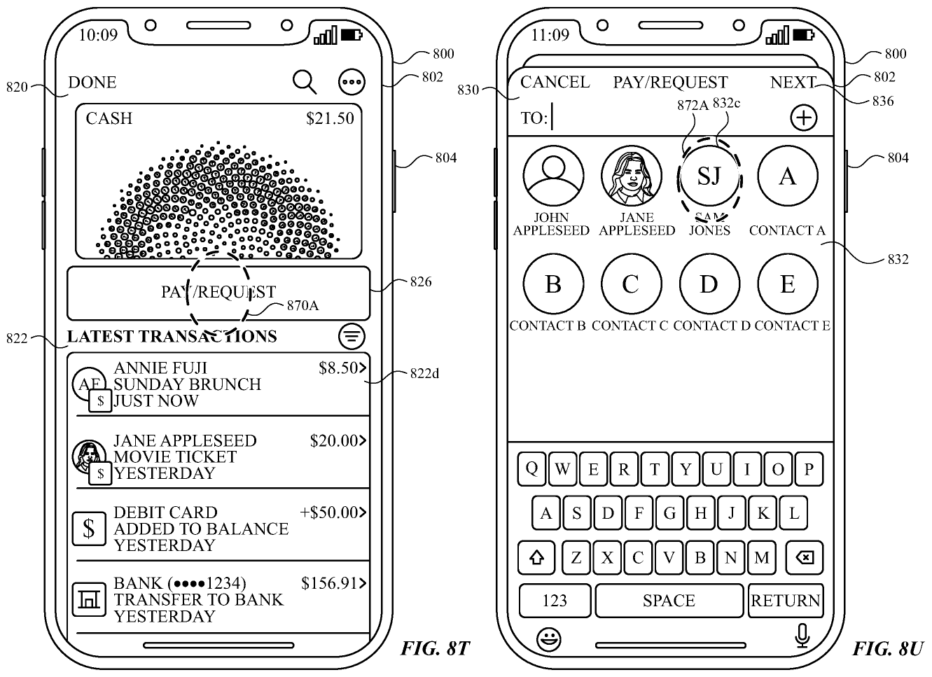

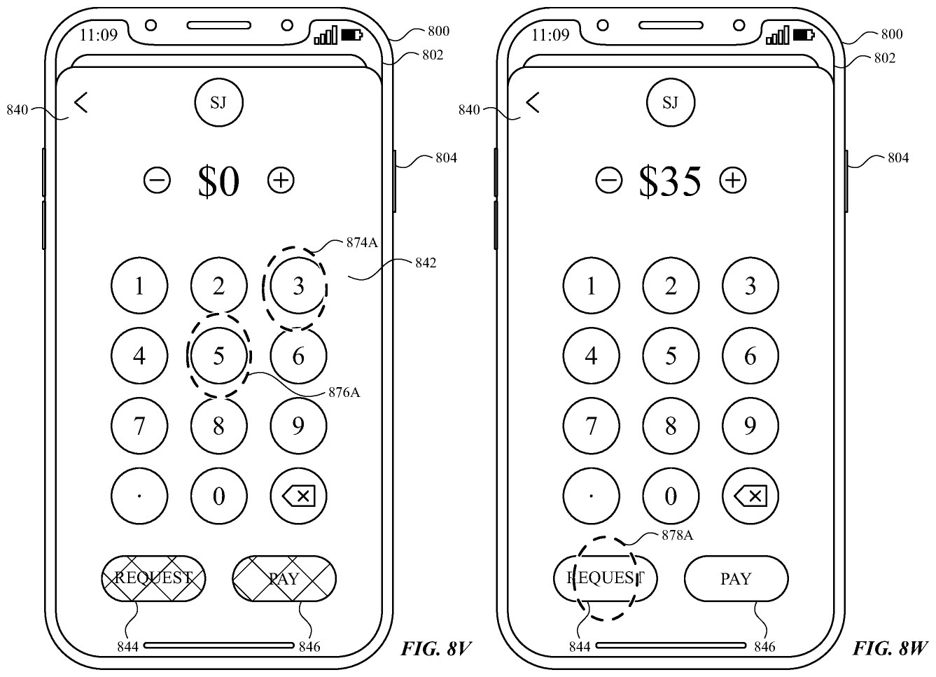

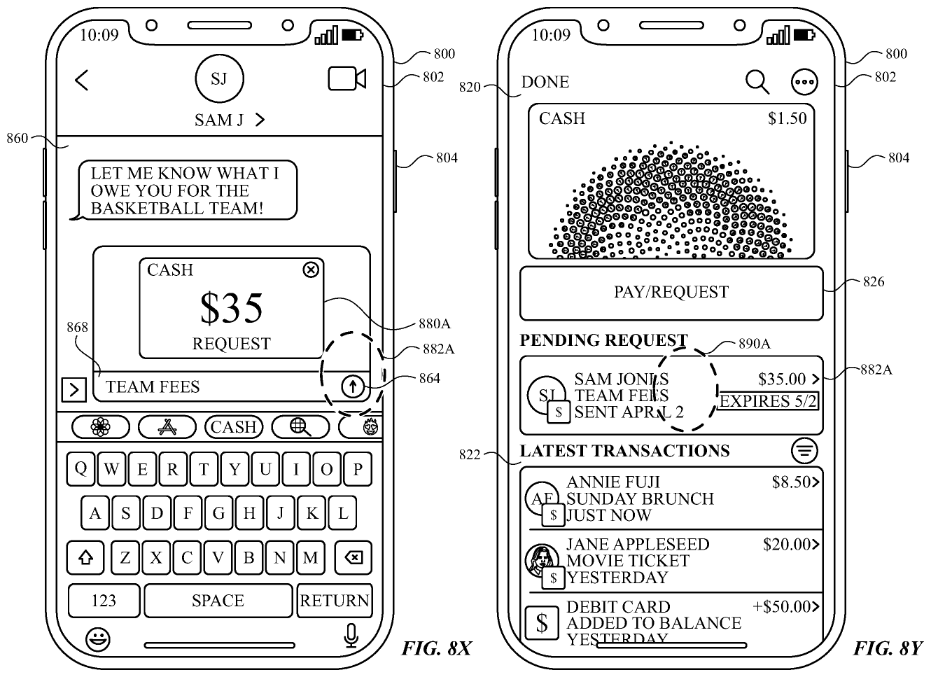

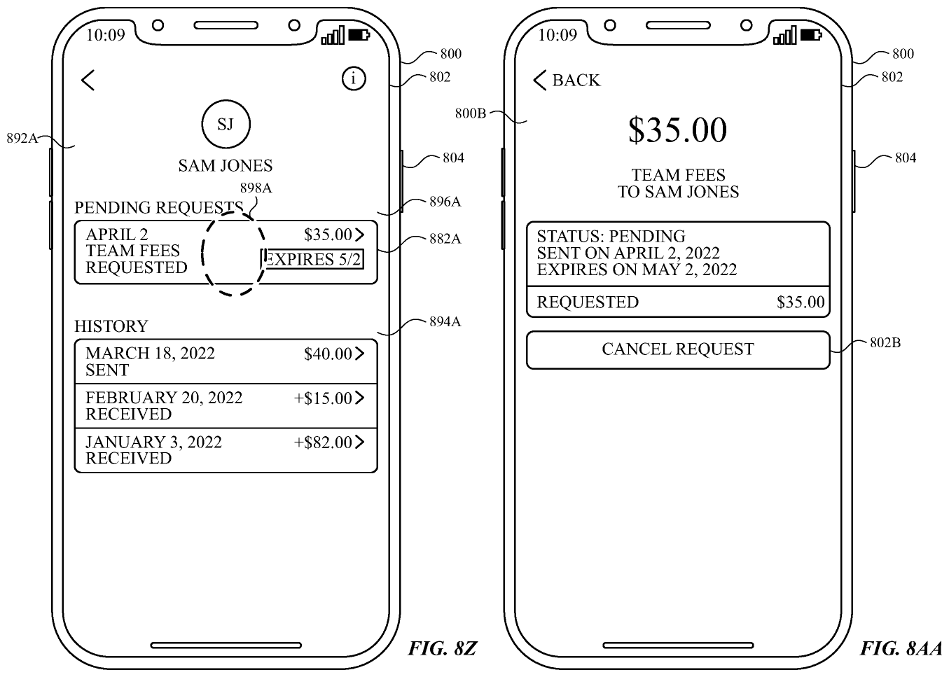

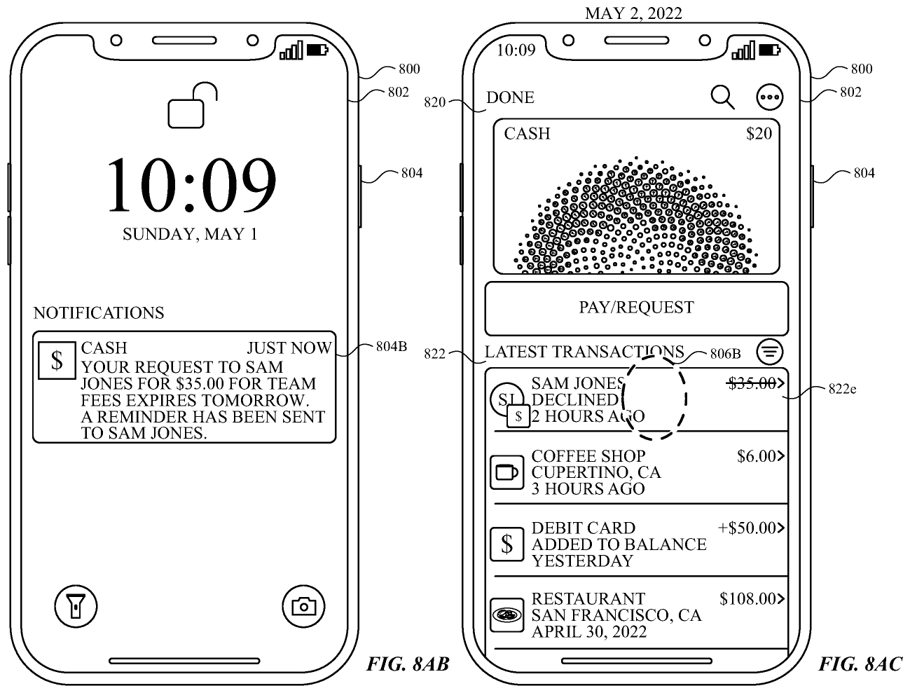

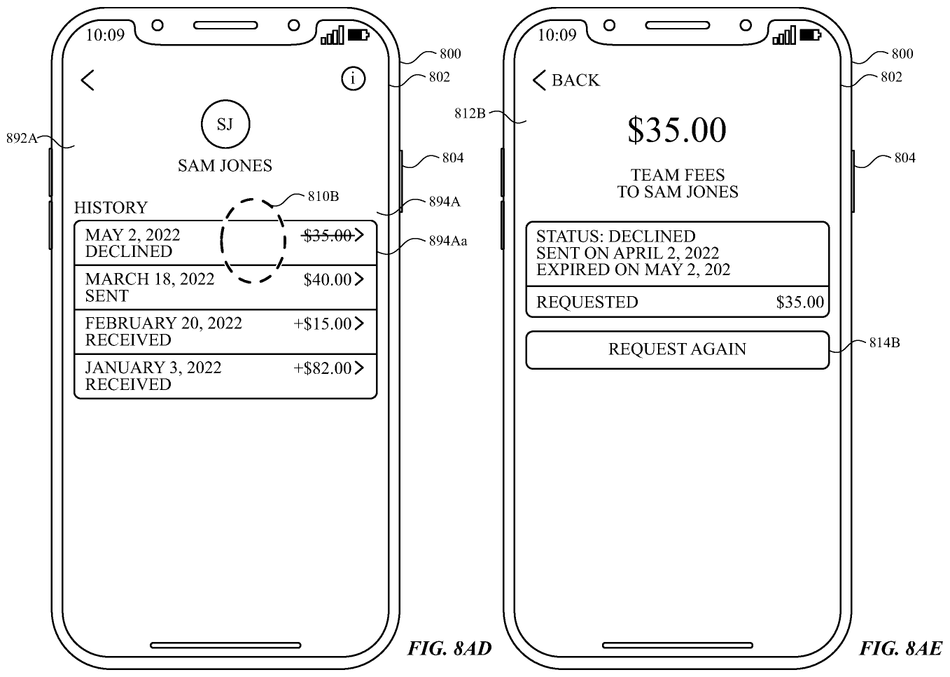

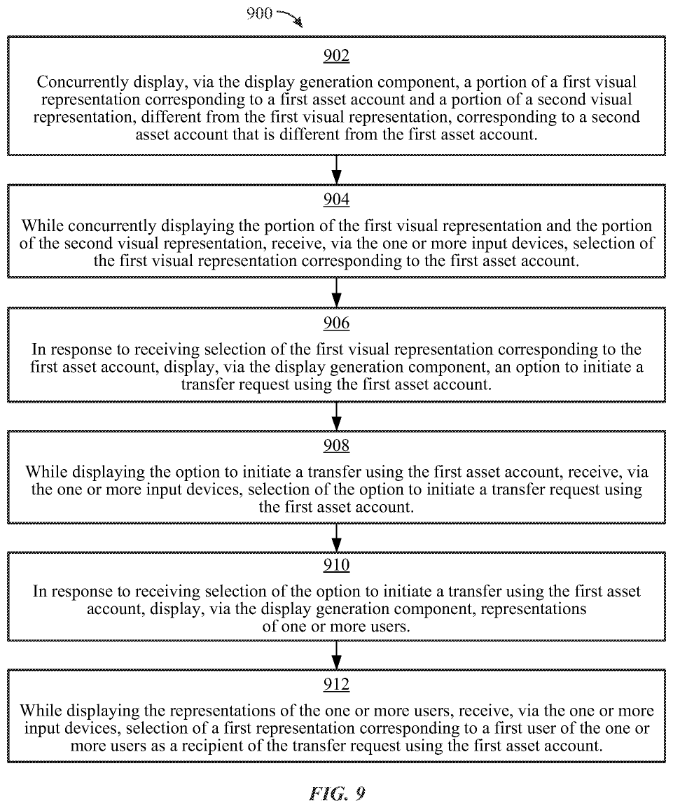

Below, FIGS. 1A-1B, 2, 3, 4A-4B, and 5A-5B provide a description of exemplary devices for performing the techniques for managing event notifications. FIGS. 7A-7I illustrate exemplary user interfaces for initiating a transaction for remote data storage associated with a user account. FIGS. 8A-8AE illustrate exemplary user interfaces for initiating a transaction for a user account. FIG. 9 is a flow diagram illustrating methods of initiating a transaction for a user account in accordance with some embodiments. The user interfaces in FIGS. 7A-7I and FIGS. 8A-8AE are used to illustrate the processes described below, including the processes in FIG. 9.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VoIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

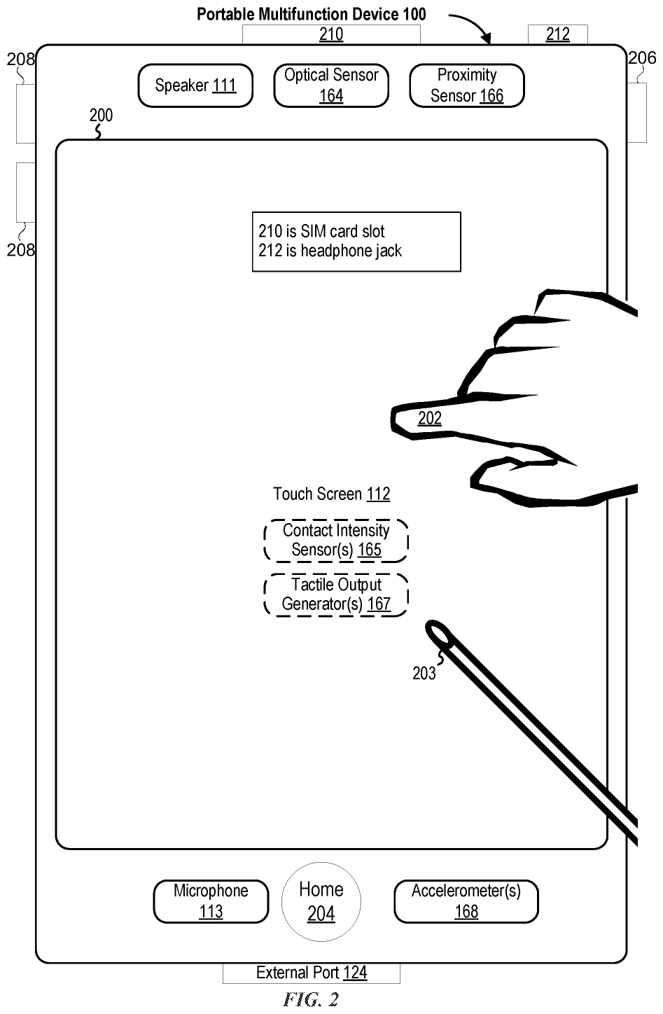

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106. Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers. Device 100 optionally includes, in addition to accelerometer(s) 168, a magnetometer and a GPS (or GLONASS or other global navigation system) receiver for obtaining information concerning the location and orientation (e.g., portrait or landscape) of device 100.

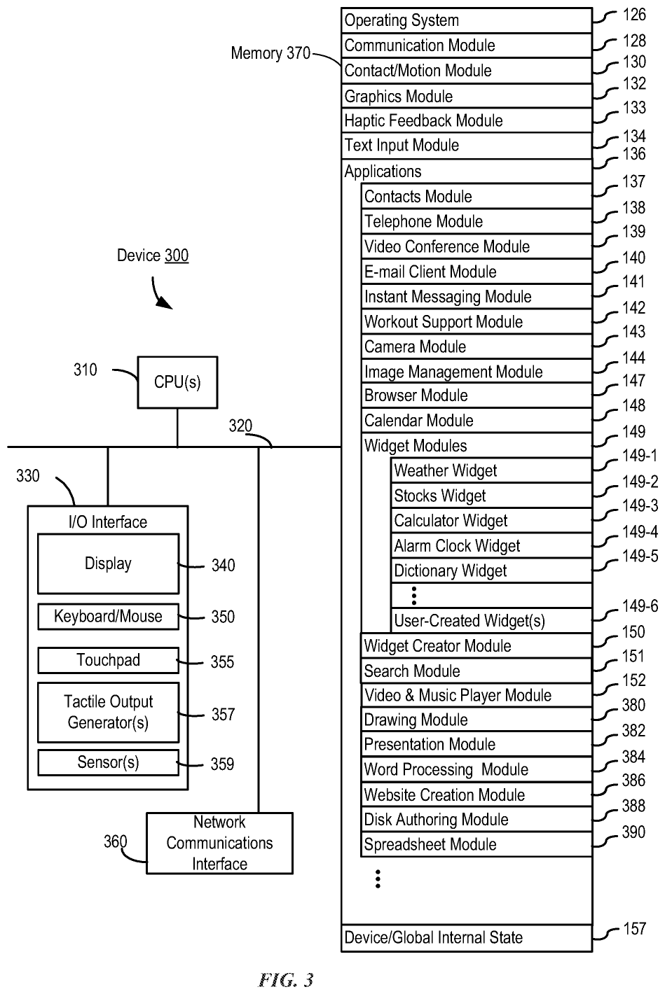

In some embodiments, the software components stored in memory 102 include operating system 126, communication module (or set of instructions) 128, contact/motion module (or set of instructions) 130, graphics module (or set of instructions) 132, text input module (or set of instructions) 134, Global Positioning System (GPS) module (or set of instructions) 135, and applications (or sets of instructions) 136. Furthermore, in some embodiments, memory 102 (FIG. 1A) or 370 (FIG. 3) stores device/global internal state 157, as shown in FIGS. 1A and 3. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, iOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts 137, e-mail 140, IM 141, browser 147, and any other application that needs text input).

GPS module 135 determines the location of the device and provides this information for use in various applications (e.g., to telephone 138 for use in location-based dialing; to camera 143 as picture/video metadata; and to applications that provide location-based services such as weather widgets, local yellow page widgets, and map/navigation widgets).

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference module 139, e-mail 140, or IM 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370 (FIG. 3) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3 is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3 is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Attention is now directed towards embodiments of user interfaces that are, optionally, implemented on, for example, portable multifunction device 100.

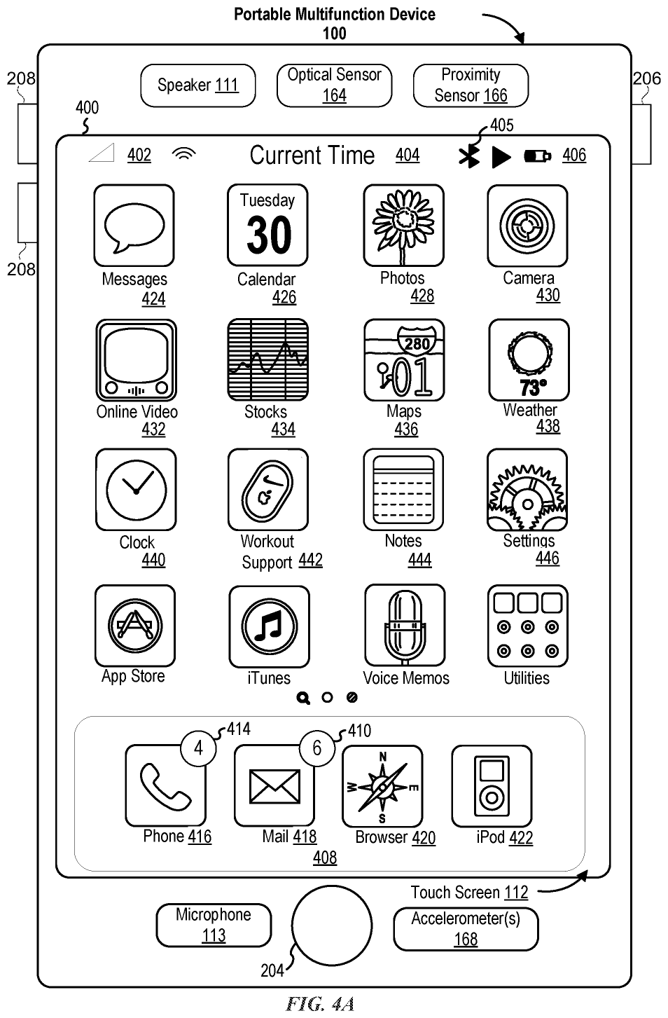

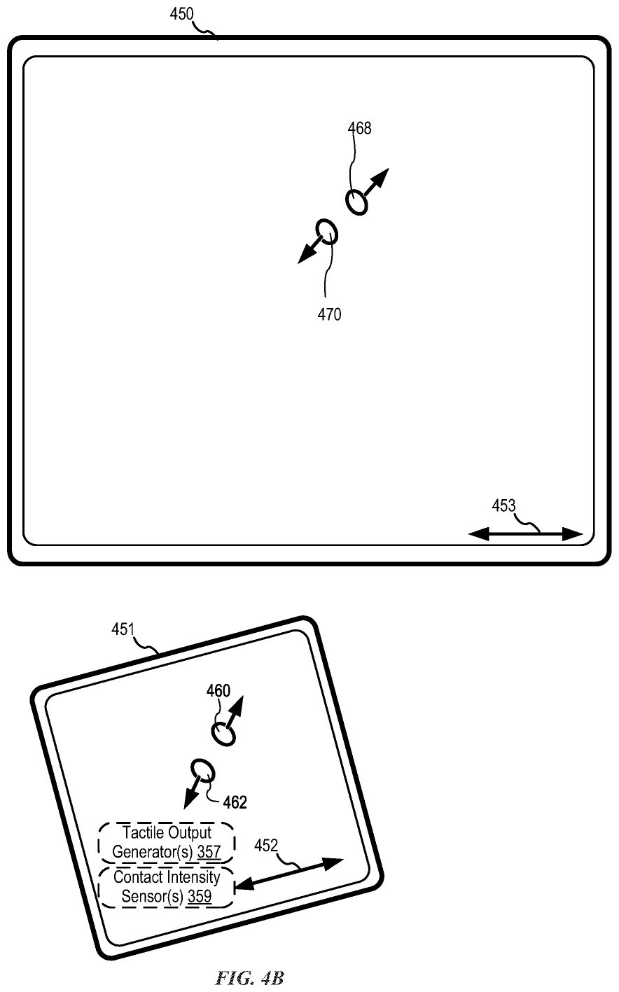

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3) with a touch-sensitive surface 451 (e.g., a tablet or touchpad 355, FIG. 3) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

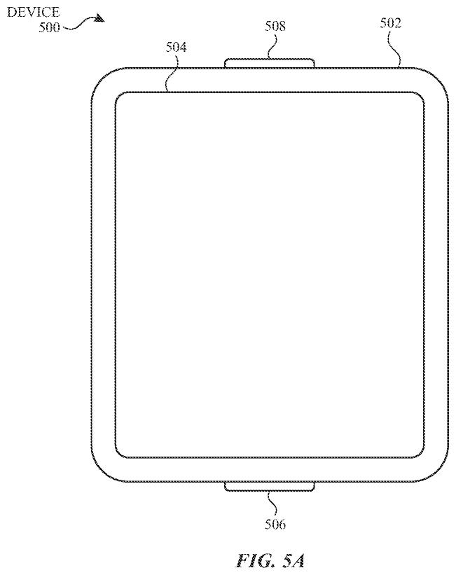

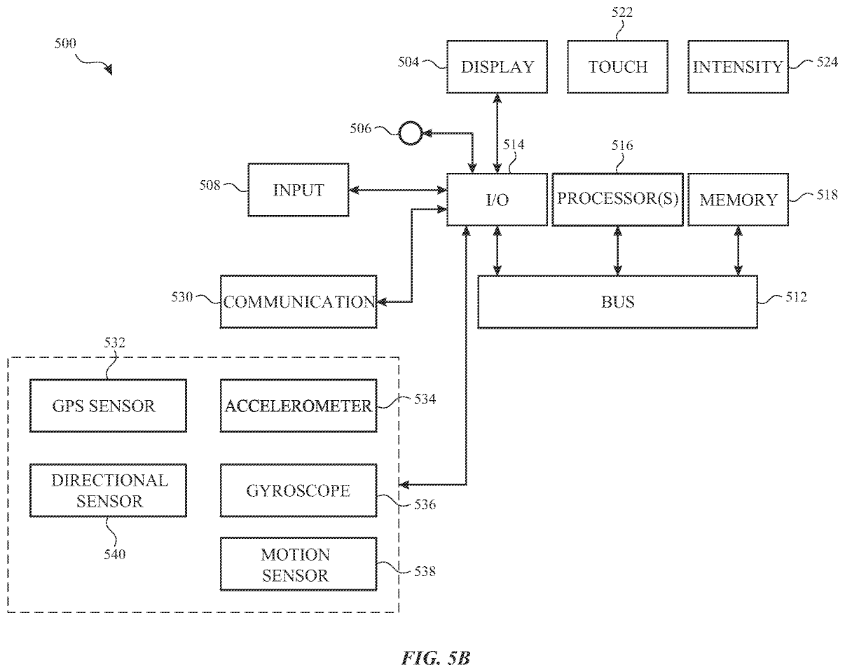

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including process 900 (FIG. 9). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

As used here, the term “affordance” refers to a user-interactive graphical user interface object that is, optionally, displayed on the display screen of devices 100, 300, and/or 500 (FIGS. 1A, 3, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3 or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

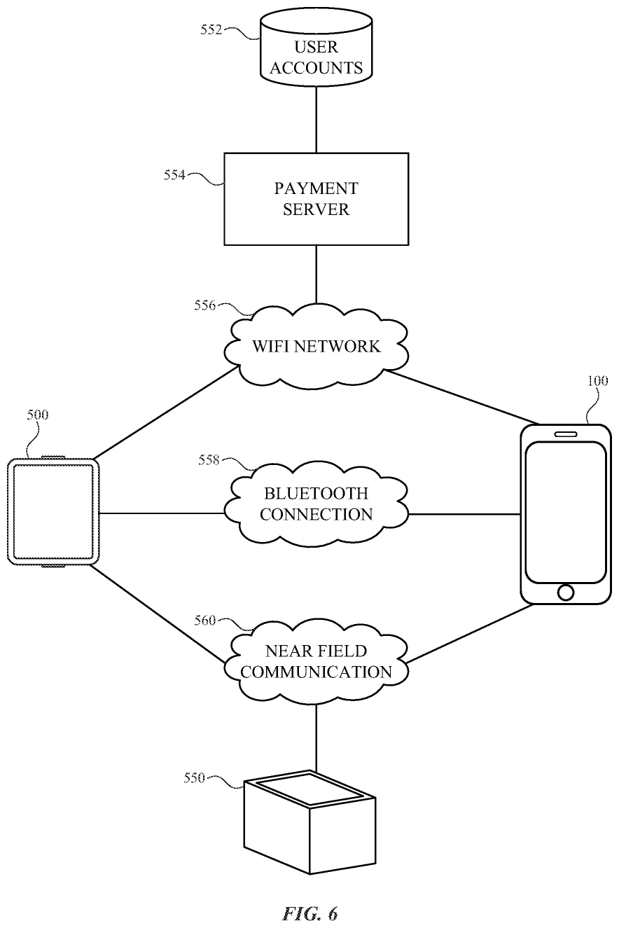

FIG. 6 illustrates exemplary devices connected via one or more communication channels to participate in a transaction in accordance with some embodiments. One or more exemplary electronic devices (e.g., devices 100, 300, and 500) are configured to optionally detect input (e.g., a particular user input, an NFC field) and optionally transmit payment information (e.g., using NFC). The one or more electronic devices optionally include NFC hardware and are configured to be NFC-enabled.

The electronic devices (e.g., devices 100, 300, and 500) are optionally configured to store payment account information associated with each of one or more payment accounts. Payment account information includes, for example, one or more of: a person's or company's name, a billing address, a login, a password, an account number, an expiration date, a security code, a telephone number, a bank associated with the payment account (e.g., an issuing bank), and a card network identifier. In some embodiments, payment account information includes include an image, such as a picture of a payment card (e.g., taken by the device and/or received at the device). In some embodiments, the electronic devices receive user input including at least some payment account information (e.g., receiving user-entered credit, debit, account, or gift card number and expiration date). In some embodiments, the electronic devices detect at least some payment account information from an image (e.g., of a payment card captured by a camera sensor of the device). In some embodiments, the electronic devices receive at least some payment account information from another device (e.g., another user device or a server). In some embodiments, the electronic device receives payment account information from a server associated with another service for which an account for a user or user device previously made a purchase or identified payment account data (e.g., an app for renting or selling audio and/or video files).

In some embodiments, a payment account is added to an electronic device (e.g., device 100, 300, and 500), such that payment account information is securely stored on the electronic device. In some embodiments, after a user initiates such process, the electronic device transmits information for the payment account to a transaction-coordination server, which then communicates with a server operated by a payment network for the account (e.g., a payment server) to ensure a validity of the information. The electronic device is optionally configured to receive a script from the server that allows the electronic device to program payment information for the account onto the secure element.

In some embodiments, communication among electronic devices 100, 300, and 500 facilitates transactions (e.g., generally or specific transactions). For example, a first electronic device (e.g., 100) can serve as a provisioning or managing device, and can send notifications of new or updated payment account data (e.g., information for a new account, updated information for an existing account, and/or an alert pertaining to an existing account) to a second electronic device (e.g., 500). In another example, a first electronic device (e.g., 100) can send data to a second election device, wherein the data reflects information about payment transactions facilitated at the first electronic device. The information optionally includes one or more of: a payment amount, an account used, a time of purchase, and whether a default account was changed. The second device (e.g., 500) optionally uses such information to update a default payment account (e.g., based on a learning algorithm or explicit user input).

Electronic devices (e.g., 100, 300, 500) are configured to communicate with each other over any of a variety of networks. For example, the devices communicate using a Bluetooth connection 558 (e.g., which includes a traditional Bluetooth connection or a Bluetooth Low Energy connection) or using a WiFi network 556. Communications among user devices are, optionally, conditioned to reduce the possibility of inappropriately sharing information across devices. For example, communications relating to payment information requires that the communicating devices be paired (e.g., be associated with each other via an explicit user interaction) or be associated with a same user account.

In some embodiments, an electronic device (e.g., 100, 300, 500) is used to communicate with a point-of-sale (POS) payment terminal 550, which is optionally NFC-enabled. The communication optionally occurs using a variety of communication channels and/or technologies. In some embodiments, electronic device (e.g., 100, 300, 500) communicates with payment terminal 550 using an NFC channel 560. In some embodiments, payment terminal 550 communicates with an electronic device (e.g., 100, 300, 500) using a peer-to-peer NFC mode. Electronic device (e.g., 100, 300, 500) is optionally configured transmit a signal to payment terminal 550 that includes payment information for a payment account (e.g., a default account or an account selected for the particular transaction).

In some embodiments, proceeding with a transaction includes transmitting a signal that includes payment information for an account, such as a payment account. In some embodiments, proceeding with the transaction includes reconfiguring the electronic device (e.g., 100, 300, 500) to respond as a contactless payment card, such as an NFC-enabled contactless payment card, and then transmitting credentials of the account via NFC, such as to payment terminal 550. In some embodiments, subsequent to transmitting credentials of the account via NFC, the electronic device reconfigures to not respond as a contactless payment card (e.g., requiring authorization before again reconfigured to respond as a contactless payment card via NFC).

In some embodiments, generation of and/or transmission of the signal is controlled by a secure element in the electronic device (e.g., 100, 300, 500). The secure element optionally requires a particular user input prior to releasing payment information. For example, the secure element optionally requires detection that the electronic device is being worn, detection of a button press, detection of entry of a passcode, detection of a touch, detection of one or more option selections (e.g., received while interacting with an application), detection of a fingerprint signature, detection of a voice or voice command, and or detection of a gesture or movement (e.g., rotation or acceleration). In some embodiments, if a communication channel (e.g., an NFC communication channel) with another device (e.g., payment terminal 550) is established within a defined time period from detection of the input, the secure element releases payment information to be transmitted to the other device (e.g., payment terminal 550). In some embodiments, the secure element is a hardware component that controls release of secure information. In some embodiments, the secure element is a software component that controls release of secure information.

In some embodiments, protocols related to transaction participation depend on, for example, device types. For example, a condition for generating and/or transmitting payment information can be different for a wearable device (e.g., device 500) and a phone (e.g., device 100). For example, a generation and/or transmission condition for a wearable device includes detecting that a button has been pressed (e.g., after a security verification), while a corresponding condition for a phone does not require button-depression and instead requires detection of particular interaction with an application. In some embodiments, a condition for transmitting and/or releasing payment information includes receiving particular input on each of multiple devices. For example, release of payment information optionally requires detection of a fingerprint and/or passcode at the device (e.g., device 100) and detection of a mechanical input (e.g., button press) on another device (e.g., device 500).

Payment terminal 550 optionally uses the payment information to generate a signal to transmit to a payment server 554 to determine whether the payment is authorized. Payment server 554 optionally includes any device or system configured to receive payment information associated with a payment account and to determine whether a proposed purchase is authorized. In some embodiments, payment server 554 includes a server of an issuing bank. Payment terminal 550 communicates with payment server 554 directly or indirectly via one or more other devices or systems (e.g., a server of an acquiring bank and/or a server of a card network).

Payment server 554 optionally uses at least some of the payment information to identify a user account from among a database of user accounts (e.g., 552). For example, each user account includes payment information. An account is, optionally, located by locating an account with particular payment information matching that from the POS communication. In some embodiments, a payment is denied when provided payment information is not consistent (e.g., an expiration date does not correspond to a credit, debit or gift card number) or when no account includes payment information matching that from the POS communication.

In some embodiments, data for the user account further identifies one or more restrictions (e.g., credit limits); current or previous balances; previous transaction dates, locations and/or amounts; account status (e.g., active or frozen), and/or authorization instructions. In some embodiments, the payment server (e.g., 554) uses such data to determine whether to authorize a payment. For example, a payment server denies a payment when a purchase amount added to a current balance would result in exceeding an account limit, when an account is frozen, when a previous transaction amount exceeds a threshold, or when a previous transaction count or frequency exceeds a threshold.

In some embodiments, payment server 554 responds to POS payment terminal 550 with an indication as to whether a proposed purchase is authorized or denied. In some embodiments, POS payment terminal 550 transmits a signal to the electronic device (e.g., 100, 300, 500) to identify the result. For example, POS payment terminal 550 sends a receipt to the electronic device (e.g., 100, 300, 500) when a purchase is authorized (e.g., via a transaction-coordination server that manages a transaction app on the user device). In some instances, POS payment terminal 550 presents an output (e.g., a visual or audio output) indicative of the result. Payment can be sent to a merchant as part of the authorization process or can be subsequently sent.

In some embodiments, the electronic device (e.g., 100, 300, 500) participates in a transaction that is completed without involvement of POS payment terminal 550. For example, upon detecting that a mechanical input has been received, a secure element in the electronic device (e.g., 100, 300, 500) releases payment information to allow an application on the electronic device to access the information (e.g., and to transmit the information to a server associated with the application).

In some embodiments, the electronic device (e.g., 100, 300, 500) is in a locked state or an unlocked state. In the locked state, the electronic device is powered on and operational but is prevented from performing a predefined set of operations in response to the user input. The predefined set of operations may include navigation between user interfaces, activation or deactivation of a predefined set of functions, and activation or deactivation of certain applications. The locked state may be used to prevent unintentional or unauthorized use of some functionality of the electronic device or activation or deactivation of some functions on the electronic device. In the unlocked state, the electronic device 100 is power on and operational and is not prevented from performing at least a portion of the predefined set of operations that cannot be performed while in the locked state.

When the device is in the locked state, the device is said to be locked. In some embodiments, the device in the locked state may respond to a limited set of user inputs, including input that corresponds to an attempt to transition the device to the unlocked state or input that corresponds to powering the device off.

In some embodiments, a secure element is a hardware component (e.g., a secure microcontroller chip) configured to securely store data or an algorithm. In some embodiments, the secure element provides (or releases) payment information (e.g., an account number and/or a transaction-specific dynamic security code). In some embodiments, the secure element provides (or releases) the payment information in response to the device receiving authorization, such as a user authentication (e.g., fingerprint authentication; passcode authentication; detecting double-press of a hardware button when the device is in an unlocked state, and optionally, while the device has been continuously on a user's wrist since the device was unlocked by providing authentication credentials to the device, where the continuous presence of the device on the user's wrist is determined by periodically checking that the device is in contact with the user's skin). For example, the device detects a fingerprint at a fingerprint sensor (e.g., a fingerprint sensor integrated into a button) of the device. The device determines whether the fingerprint is consistent with a registered fingerprint. In accordance with a determination that the fingerprint is consistent with the registered fingerprint, the secure element provides (or releases) payment information. In accordance with a determination that the fingerprint is not consistent with the registered fingerprint, the secure element forgoes providing (or releasing) payment information.

As used herein, an “installed application” refers to a software application that has been downloaded onto an electronic device (e.g., devices 100, 300, and/or 500) and is ready to be launched (e.g., become opened) on the device. In some embodiments, a downloaded application becomes an installed application by way of an installation program that extracts program portions from a downloaded package and integrates the extracted portions with the operating system of the computer system.

Attention is now directed towards embodiments of user interfaces (“UI”) and associated processes that are implemented on an electronic device, such as portable multifunction device 100, device 300, or device 500.

FIGS. 7A-7I illustrate exemplary user interfaces for initiating a transfer of remote data storage associated with a user account (e.g., a computer storage management account), in accordance with some embodiments. The user interfaces in these figures are used to illustrate the processes described below, including the processes in FIG. 9. In some instances, the computer storage management account may be referred to herein as a computer storage account, a data storage management account, a data storage account, or the like.

FIG. 7A illustrates electronic device 700. In FIG. 7A, electronic device 700 is a portable multifunction device and has one or more components described above in relation to one or more of devices 100, 300, and 500.

In FIG. 7A, electronic device 700 is displaying, on display 702 (e.g., touch screen 702), a user interface 710 of a transfer application (e.g., an electronic wallet application). In some embodiments, user interface 710 includes representations 712 (or portions thereof) corresponding to different accounts (e.g., transfer accounts) provisioned on electronic device 700. As shown, representations 712 include, for instance, representation 712a corresponding to a computer storage management account and representation 712b corresponding to a transit account. In some embodiments, representation 712a corresponds to a first-party manufacturer-issued (or branded) computer storage management account. In some embodiments, user interface 710 includes representations 714 (e.g., representations 714a-714c) corresponding to other various accounts (e.g., transfer accounts, points cards, and/or rewards cards), ID cards (e.g., student ID and/or government-issued ID), and/or tickets (e.g., event ticket and/or boarding pass ticket) provisioned on or otherwise linked to electronic device 700.

In some embodiments, the user account is a computer storage management account that provides access to (e.g., cloud-based) computer storage resources. In some embodiments, the user account allows a user to store data to and delete data from the computer storage resources (e.g., remote, cloud-based computer storage resources that are not local to electronic device 100) that can be accessed via the account. In some embodiments, the data can be different types of data, such as, for example, data corresponding to photo files, data corresponding to document files, data corresponding to music files, data corresponding to video files, and data corresponding to application files.

In some embodiments, the amount of computer storage resources of computer storage management account may be modified. For example, as described in further detail below, computer storage resources of the account are, in some instances, transferred to or received from another computer storage management account such that the amount of computer storage resources associated with the account is decreased or increased, respectively.

While displaying user interface 710, device 700 detects selection of representation 712a corresponding to the computer storage management account. The selection is a tap gesture 701 on representation 712a. As shown in FIG. 7B, in response to detecting tap gesture 701, device 700 displays storage account interface 720.

In some embodiments, storage account interface 720 includes storage transfer history 722, which shows a plurality of recent account activities corresponding to requests to transfer computer storage resources. As an example, storage transfer history 722 includes a first transfer 722a corresponding to a request to transfer an amount (e.g., 50 MB) of computer storage resources from another user account to the computer storage management account. As another example, storage transfer history 722 includes a second transfer 722b corresponding to a request to transfer an amount (e.g., 150 MB) of computer storage resources from the computer storage management account to another user account. As shown, each of the transfers 722 includes a date indicating a date upon which the request for the transfer was made (or when the respective operation was completed).

In some embodiments, storage account interface 720 further includes a filter affordance 724, which when selected, filters the storage transfer history 722 such that a user may view a curated set of transfers of the storage transfer history 722 in storage account interface 720 (e.g., transfers corresponding to requests to transfer computer storage resources to the computer storage management account).

In some embodiments, storage account interface 720 further includes transfer affordance 726, which when selected, initiates a process for requesting transfer of computer storage resources associated with the computer storage management account. For example, while displaying storage account interface 720, device 700 detects selection of request affordance 726. In some embodiments, the selection is a tap gesture 728 on affordance 726. As shown in FIG. 7C, in response to detecting tap gesture 728, device 700 displays selection interface 730. In some embodiments, selection interface 730 is overlaid on storage account interface 720.

Generally, selection interface 730 allows a user of device 700 to select a contact (e.g., a contact stored on device 700) as a recipient of a transfer request. For example, while displaying selection interface 730, device 700 detects selection of contact 732b (e.g., “Jane Appleseed”) of contacts 732. In some embodiments, the selection is a tap gesture 734 on contact 732b. As shown in FIG. 7D, once a contact has been selected, and optionally, confirmed (e.g., by selection of next affordance 736 in FIG. 7C), device 700 displays quantity user interface 740.

In some embodiments, quantity user interface 740 can be used to specify an amount of computer storage resources to be transferred. For example, while displaying quantity user interface 740, device 700 detects a set of inputs specifying an amount of computer storage resources. As shown in FIGS. 7D-7E, device 700 detects a set of inputs (e.g., inputs 748a, 748b) specifying an amount of 20 MB.

In some embodiments, quantity user interface 740 can also be used to specify a type of request to transfer. For example, in response to detecting input specifying an amount of computer storage resources, device 700 modifies a visual characteristic of request affordance 744 and send affordance 746 to indicate request affordance 744 and send affordance 746 have become selectable (e.g., transitioned from a non-selectable state to a selectable state). In some embodiments, modifying a visual characteristic of an affordance in this manner includes changing a color of the affordance, shape of the affordance, size of the affordance, or any combination thereof. Thereafter, device 700 detects selection of request affordance 744 or send affordance 746. In response to selection of request affordance 744, device 700 initiates a process for requesting transfer of computer storage resources from an account of the selected contact to the computer storage management account.

In response to selection of send affordance 746, device 700 initiates a process for requesting transfer of computer storage resources from the computer storage management account to an account of the selected contact. For example, while displaying quantity user interface 740, device 700 detects selection of send affordance 746. In some embodiments, the selection is a tap gesture 750 on send affordance 746. As shown in FIG. 7F, in response to detecting selection of send affordance 746, device 700 displays a message interface 760 (e.g., of a messaging application).

In some embodiments, message interface 760 includes request 762 (displayed as a transfer message object), which is a request to transfer the indicated amount of computer storage resources (e.g., 20 MB) to the selected contact. In some embodiments, request 762 is displayed inside of a compose area of the message interface 760 to indicate that the request to transfer computer storage resources has not yet been sent to the selected contact. In some embodiments, request 762 indicates the amount specified by the user. In some embodiments, message interface 760 further includes a field 768 in which a comment (e.g., “movie storage”) and/or other information describing the request may be provided. As shown in FIG. 7G, in response to selection of send affordance 764 of FIG. 7F (e.g., a tap gesture 766 on send affordance 764), device 700 displays confirmation interface 770. In some embodiments, confirmation interface 770 is overlaid on at least a portion of messaging interface 760.

Confirmation interface 770 includes account indicator 772, transfer summary 774, and input instruction 776. Account indicator 772 identifies the computer storage management account and, optionally, lists the amount of computer storage resources currently associated with the computer storage management account. In some embodiments, transfer summary 774 indicates the type of request to be provided (e.g., send, request), the selected contact, and/or the amount of computer storage resources to be transferred. Input instruction 776 indicates that the request will be provided (e.g., to the selected contact) in response to a double press (e.g., “double click”) of button 704. At FIG. 7G, device 700 detects double press input 778 on button 704.

In response to detecting double press input 778, device 700 provides the request to transfer computer storage resources to the selected contact. As shown in FIG. 7H, after providing the request, device 700 adds the request to storage transfer history 722 in storage account interface 720 (e.g., as transfer 722c). Because the selected contact has not yet accepted the request, the request is indicated as “pending”. As shown in FIG. 7I, once the selected contact accepts the request, the request is fulfilled (e.g., 20 MB of computer storage resources are transferred from the computer storage management account to the user account for Jane Appleseed) and transfer 722c is no longer indicated as “pending.”

While description is made herein with respect to providing a request to transfer computer storage resources in response to detection of a double click input 728 (FIG. 7G), it will be appreciated that a request to transfer computer storage resources may be provided in response to a number of other inputs detected during the process to provide a transfer request. By way of example, in some instances a request may be sent in response to selection of request affordance 744 or send affordance 746 (FIGS. 7D, 7E). In this manner, device 700 can, optionally, forego display of message interface 760 and/or user confirmation (e.g., as provided by double click input 728) prior to sending the request.

In some embodiments, the manner in which one or more elements of user interfaces described herein may vary. By way of example, in some embodiments, transfer affordance 726 (FIG. 7B) may be replaced by both a request affordance, which when selected initiates a process for requesting transfer of computer storage resources from another user account to the computer storage management account, and a send affordance, which when selected initiates a process for requesting transfer of computer storage resources from the computer storage management account to another user account. Additionally or alternatively, in some embodiments, the request affordance 744 and send affordance 746 (FIGS. 7D, 7E) may be replaced by a confirmation affordance, which when selected confirms an amount of computer storage resources indicated by a user.

FIGS. 8A-8AE illustrate exemplary user interfaces for initiating a transaction for a user account (e.g., a transfer account), in accordance with some embodiments. The user interfaces in these figures are used to illustrate the processes described below, including the processes in FIG. 9.

In some embodiments, the user account is a transfer account. In some embodiments, the transfer account is a first-party transfer account (e.g., a transfer account that is issued or branded by, for example, the manufacturer of the electronic device), and, optionally, provides rewards (e.g., cash back rewards, bonus points rewards) based on the amount of transfers (e.g., payment transactions and/or points transfers) made using the transfer account (e.g., cash back rewards that are based on a certain percentage of the value of each transaction) and/or made using a different account. In some embodiments, the transfer account is a points account (e.g., for meal points, for printer credits, and/or for membership points) that provides rewards (e.g., points rewards) based on the amount of points used using the transfer account.

FIGS. 8A-8I illustrate an example in which a user provides a request to transfer funds from a transfer account to an account of another user.

FIG. 8A illustrates electronic device 800. In FIG. 8A, electronic device 800 is a portable multifunction device and has one or more components described above in relation to one or more of devices 100, 300, and 500.

In FIG. 8A, electronic device 800 is displaying, on display 802 (e.g., touch screen 802), a user interface 810 of a transfer application (e.g., an electronic wallet application). In some embodiments, user interface 810 includes representations 812 corresponding to different transfer accounts (e.g., payment accounts, such as a third-party credit card account, a debit card account, and/or a stored-value account; points accounts; and/or rewards accounts) provisioned on the electronic device. As shown, representations 812 include, for instance, a representation 812a corresponding to a transfer account and a representation 812b corresponding to a transit account. In some embodiments, representation 812a corresponds to a first-party transfer account. In some embodiments, user interface 810 includes representations 814 (e.g., representations 814a-814c) corresponding to other various accounts (e.g., transfer accounts, points cards, and/or rewards cards), ID cards (e.g., student ID and/or government-issued ID), and/or tickets (e.g., event ticket and/or boarding pass ticket) provisioned on or otherwise linked to the electronic device 800.

While displaying user interface 810, device 800 detects selection of representation 812a corresponding to the transfer account. In some embodiments, the selection of representation 812a is a tap gesture 801 on representation 812a of the transfer account. As shown in FIG. 8B, in response to detecting tap gesture 801, device 800 displays transfer account interface 820.

In some embodiments, transfer account interface 820 includes transfer history 822, which shows a plurality of recent account activities corresponding to previously requested transfers (e.g., transfers of funds) associated with the transfer account. As an example, transfer history 822 includes a first transfer 822a corresponding to a request to transfer a specified amount (e.g., $50.00) to the transfer account. As another example, transfer history 822 includes a second transfer 822b corresponding to a request to transfer a specified amount (e.g., $156.91) from the transfer account. As shown, first transfer 822a and second transfer 822b of the transfers 822 include respective dates indicating, for example, a date upon which the request for the transfer was made (or when the respective operation was completed).

In some embodiments, transfer account interface 820 further includes a filter affordance 824, which when selected, filters the transfer history 822 such that a user may view a curated set of transfers of transfer history 822 (e.g., transfers corresponding to requests to transfer funds to the transfer account).

In some embodiments, transfer account interface 820 further includes transfer affordance 826, which when selected, initiates a process for requesting a transfer using the transfer account. For example, while displaying transfer account interface 820, device 800 detects selection of transfer affordance 826. In some embodiments, the selection is a tap gesture 828 on transfer affordance 826. As shown in FIG. 8C, in response to detecting tap gesture 828, device 800 displays selection interface 830. In some embodiments, selection interface 830 is overlaid on transfer account interface 820.

Generally, selection interface 830 allows a user of device 800 to select a contact (e.g., a contact stored on device 800) as a recipient of a transfer request. For example, while displaying selection interface 830, device 800 detects selection of contact 832b (e.g., “Jane Appleseed”) of contacts 832. In some embodiments, the selection is a tap gesture 834 on contact 832b. As shown in FIG. 8D, once a contact has been selected, and optionally, confirmed (e.g., by selection of next affordance 836), device 800 displays quantity user interface 840.

In some embodiments, quantity user interface 840 can be used to specify an amount of funds to be transferred. For example, while displaying quantity user interface 840, device 800 detects a set of inputs specifying an amount. As shown in FIGS. 8D-8E, device 800 detects, at keypad 842, a set of inputs (e.g., inputs 848a and 848b) specifying an amount of money, e.g., $20.00.

In some embodiments, quantity user interface 840 can also be used to specify a type of request to transfer. For example, in response to detecting a set of inputs specifying an amount to be transferred, device 800 modifies a visual characteristic of request affordance 844 and pay affordance 846 to indicate request affordance 844 and pay affordance 846 have become selectable. In some embodiments, modifying a visual characteristic of an affordance in this manner includes changing a color of the affordance, shape of the affordance, size of the affordance, or any combination thereof. Thereafter, device 800 detects selection of request affordance 844 or pay affordance 846. In response to selection of request affordance 844, device 800 initiates a process for requesting transfer of funds from an account of the selected contact to the transfer account.

In response to selection of pay affordance 846, device 800 initiates a process for requesting transfer of funds from the transfer account to an account of the selected contact. For example, while displaying quantity user interface 840, device 800 detects selection of pay affordance 846. The selection is a tap gesture 850 on pay affordance 846. As shown in FIG. 8F, in response to detecting selection of pay affordance 846, device 800 displays a message interface 860 (e.g., of a messaging application).

In some embodiments, message interface 860 includes request 862 (displayed as a transfer message object), which is a request to transfer the indicated amount of funds (e.g., $20.00) to an account of the selected contact. In some embodiments, request 862 is displayed inside of a compose area of the message interface 860 to indicate that the request to transfer funds has not yet been sent to the selected contact. In some embodiments, request 862 indicates the amount specified by the user. In some embodiments, message interface 860 further includes field 868 in which information describing the request (e.g., “movie ticket”) may be provided. As shown in FIG. 8G, in response to selection of send affordance 864 (e.g., tap gesture 866 on send affordance 864), device 800 displays confirmation interface 870. In some embodiments, confirmation interface 870 is overlaid on at least a portion of messaging interface 860.

Confirmation interface 870 includes account indicator 872, transfer summary 874, and input instruction 876. Account indicator 872 identifies the transfer account and, optionally, lists a balance currently associated with the transfer account. In some embodiments, transfer summary 874 indicates the type of request to be provided (e.g., send or request), the selected contact, and/or the amount of funds to be transferred. Input instruction 876 indicates that the request will be provided to the selected contact in response to a double press (e.g., “double click”) of button 804. At FIG. 8G, device 800 detects double press input 878 on button 804.

In response to detecting double press input 878, device 800 provides the request to transfer funds to the selected contact. As shown in FIG. 8H, after providing the request, device 800 adds the request to transfer history 822 in transfer account interface 820 (e.g., as transfer 822c). In some embodiments, the user interface of FIG. 8H is displayed in response to detecting double press input 878 (e.g., without displaying the request as part of a conversation transcript between the user of device 800 and the selected contact or after displaying the request as part of the conversation). At FIG. 8H, because the selected contact has not yet accepted the request, the request is indicated as “pending”. As shown in FIG. 8I, once the selected contact receives and accepts the request, the request is fulfilled (e.g., $20.00 is transferred to Jane Appleseed's account) and transfer 822c is no longer indicated as “pending.”

In some embodiments, upon the selected contact accepting the request, a device of the selected contact provides (e.g., displays) one or more notifications corresponding to the transaction. For example, as shown in FIG. 8I, after the selected contact has accepted the request, device 880 associated with the selected contact (e.g., Jane Appleseed's device) displays notification 884 and/or notification 886. In some embodiments, notification 884 indicates the amount that has been transferred to the account of the selected contact as a result of the transfer (e.g., $20.00) and, optionally, information describing one or more aspects of the transfer, such as a comment originally provided with the request (e.g., “movie ticket”). In some embodiments, notification 886 indicates that the account of the selected contact has received funds and, optionally, indicates a new balance for the account (e.g., $25.00). In some embodiments, notifications corresponding to 804 and 806 are displayed at device 800, providing the user of device 800 with feedback that the request has been accepted and the new balance for transfer account for the user of device 800.

While description is made herein with respect to providing a request to transfer funds in response to detection of a double click input 828 (FIG. 8G), it will be appreciated that a request to transfer funds may optionally be provided in response to a number of other inputs detected during the process to provide a request. By way of example, in some instances a request may be sent in response to selection of request affordance 844 or pay affordance 846 (FIGS. 8D, 8E). In this manner, device 800 can, optionally, forego display of message interface 860 and/or user confirmation (e.g., as provided by double click input 828) prior to sending the request.

In some embodiments, the manner in which one or more elements of user interfaces described herein may vary. By way of example, in some embodiments, transfer affordance 826 (FIG. 8B) may be replaced by both a request affordance, which when selected initiates a process for requesting transfer of funds from another user account to the transfer account, and a pay affordance, which when selected initiates a process for requesting transfer of funds from the transfer account to another user account. Additionally or alternatively, in some embodiments, the request affordance 844 and pay affordance 846 (FIGS. 8D, 8E) may be replaced by a confirmation affordance, which when selected confirms an amount of funds indicated by a user.

In some embodiments, transfer affordance 826 of FIG. 8B (and of 8T), when selected, causes device 800 to display two options for proceeding with the transfer request: an option to send funds and an option to request funds. In some embodiments, the two options are overlaid on transfer account interface 820. In response to detecting selection of one of the two options (e.g., selection of the option to send funds or selection of the option to request funds), device 800 displays selection interface 830 and continues with the technique. In some embodiments, because the user has already selected whether to send or request funds, the request affordance 844 and pay affordance 846 (FIGS. 8D-8E and/or 8V-8W) may be replaced by a confirmation affordance, which when selected confirms the displayed amount of funds.

With reference once again to FIG. 8I, in some embodiments, a user may filter display of a transfer history, such as transfer history 822 (FIG. 8B). For example, as shown in FIG. 8I, device 800 detects selection of filter affordance 824 while displaying transfer account interface 820. In some embodiments, the selection is a tap gesture 892 on filter affordance 824. As shown in FIG. 8J, in response to detecting tap gesture 892, device 800 displays filter menu 890. In some embodiments, filter menu 890 is overlaid on transfer account interface 820.

Filter menu 890 includes filter options 890a-890f, each of which corresponds to a particular manner in which transfer history 822 may be filtered. Filter option 890a (e.g., “all”) causes device 800 to filter transfer history such that all transfers are included in the results (e.g., any existing filters are removed such that no filter is applied) and/or such that no transfers are excluded from the results (e.g., displayed). Filter option 890b (“requested”) causes device 800 to filter transfer history 822 such that only transfers corresponding to pending requests for transferring funds from the transfer account to another account are included in the results (e.g., displayed). Filter option 890d (“daily cash”) causes device 800 to filter transfer history 822 such that only transfers corresponding to rewards (e.g., cash rewards) earned for the transfer account are included in the results (e.g., displayed). Filter option 890e (“pending requests”) causes device 800 to filter transfer history 822 such that only pending requests for transferring of funds from another account to the transfer account are included in the results (e.g., displayed). Filter option 890f (“purchases”) causes device 800 to filter transfer history 822 such that only transfers corresponding to purchases made using funds of the transfer account are included in the results (e.g., displayed).

Filter option 890c (“paid”) causes device 800 to filter transfer history 822 such that only transfers corresponding to completed requests for a transfer of funds from the transfer account to another account are included in the results (e.g., displayed). For example, as shown in FIG. 8J, while displaying filter menu 890, device 800 detects selection of filter option 890c. In some embodiments, the selection of filter option 890c is a tap gesture 892. As shown in FIG. 8K, in response to detecting tap gesture 892, device 800 filters transfer history 822 according to the “paid” filter (e.g., only completed transfers for the transfer of funds from the transfer account to another user account are included in the results). In some embodiments, when a filter is applied to the transfer history 822, device 800 modifies one or more visual characteristics of (e.g., darkens or highlights) filter affordance 824, for instance, to indicate that the transfer history 822 is filtered.

In some embodiments, transfer account interface 820 includes a search affordance which may be used to search transfer history 822. For example, while displaying transfer account interface 820, device 800 detects selection of search affordance 894. In some embodiments, the selection is a tap gesture 896 on search affordance 894. As shown in FIG. 8L, in response to detecting selection of search affordance 894, device 800 displays search interface 800A.

Search interface 800A includes a number of affordances by which transfer history 822 may be searched. As an example, search interface 800A includes filter affordances 802A, which correspond to filter options 890b-890f, respectively. In response to detecting selection of a filter affordance 802A, device 800 filters transfer history 822 in the manner previously described with respect to filter options 890b-890f.

As another example, search interface 800A includes contact affordances 804A, each of which corresponds to a contact (e.g., friend, family, and/or coworker) stored at device 800. In some examples, contact affordances 804A additionally or alternatively include affordances corresponding to user accounts with which a transfer was made within a threshold amount of time (e.g., within the last 10 days, within the last 30 days). In some embodiments, contact affordances 804A additionally or alternatively include affordances corresponding to user accounts with which transfers were most recently conducted (e.g., contacts for the most recent 6 transfers). In response to detecting selection of a contact affordance 804A, device 800 filters transfer history 822 according to the selected contact affordance 804A. If, for instance, device 800 detects selection of contact affordance 804Aa corresponding to a contact “John Appleseed”, device 800 filters transfer history 822 such that only transfers associated with (e.g., from and/or to) the contact “John Appleseed” are displayed.

As yet another example, search interface 800A includes merchant affordances 806A, each of which corresponds to a merchant. In some embodiments, merchant affordances 806A correspond to a predetermined set of merchants (e.g., as determined by a manufacturer of device 800) and/or merchants with which a transfer was made within a threshold amount of time. In response to detecting selection of a merchant affordance 806A, device 800 filters transfer history 822 according to the selected merchant affordance 806A. If, for instance, device 800 detects selection of merchant affordance 806A corresponding to merchant “W”, device 800 filters transfer history 822 such that only transfers associated with the merchant “W” are displayed.

FIGS. 8M-8S illustrate an example operation in which a user has received a request for a transfer of funds from the transfer account to the account of another user.

FIGS. 8M-80 describe various notifications indicating that a request to transfer of funds from the transfer account has been received. In FIG. 8M, device 800 displays notification 810A on a lock screen interface indicating that another user (e.g., “Annie Fuji”) has provided a request for a transfer of funds from the transfer account for a specified amount (e.g., “$8.50”). In some embodiments, notification 810A further includes information regarding the requested transfer, such as a comment indicating a reason for the request (“Sunday Brunch”).

In some instances, a user associated with the transfer account may not approve a request for transfer of funds at a time that the request is received. The user may either elect not to approve the request (but not decline) or may simply forget to approve the request despite intending to do so. Accordingly, if a predetermined amount of time has passed since a request for a transfer of funds is received (e.g., 14 days or 29 days) and/or a predetermined amount of time remains before the request expires (e.g., 1 day or 1 week), device 800 displays one or more notifications reminding the user of the previous request. In some embodiments, such notifications are displayed on a lock screen interface (e.g., notification 814A of FIG. 8N) and/or displayed in a user interface of a transfer application (e.g., notification 820A of FIG. 8O). As shown in FIGS. 8N-8O, notifications displayed in this manner indicate a date of the request to transfer funds, and optionally, indicate when the request will expire.

In some embodiments, selection of a notification displayed by device 800 indicating that a transfer of funds has been requested initiates a process for accepting or declining the request. By way of example, in response to detecting selection of notification 810A (or either of notifications 814A, 820A), device 800 displays transfer account interface 820 as shown in FIG. 8P. Because a request to transfer funds is pending, transfer account interface 820 includes request 830A. In some embodiments, request 830A is displayed above transfer history 822 such that request 830A is displayed in a prominent manner. Request 830A includes dismiss option 832A which may be used to remove request 830A from transfer account interface 820, and optionally, decline request 830A. For example, while displaying transfer account interface 820, device 800 detects selection of dismiss option 832A. In some embodiments, the selection is a tap gesture 834A on dismiss option 832A. As shown in FIG. 8Q, in response to detecting tap gesture 834A, device 800 displays decline interface 840A. In some embodiments, decline interface 840A is overlaid on at least a portion of transfer account interface 820.

Decline interface 840 includes dismiss affordance 842A, which when selected, causes device 800 to remove request 830A from transfer account interface 820. In some embodiments, request 830A is removed permanently. In other embodiments, request 830A is removed for an amount of time such that the user is later reminded about the pending request. Decline interface 840A further includes decline affordance 844A, which when selected, causes device 800 to remove request 830A from transfer account interface 820 and decline the request to transfer funds from the transfer account. In some embodiments, declining the request causes transfer history 822 to be updated to reflect that the request was declined (e.g., by including information from the request with font style that is crossed out).

With reference to FIG. 8P, request 830A further includes accept affordance 836A which may be used to initiate a process to accept the request to transfer funds associated with request 830A. For example, while displaying transfer account interface 820, device 800 detects selection of accept affordance 836A. In some embodiments, the selection is a tap gesture 832A on accept affordance 836A. In some embodiments, in response to detecting tap gesture 836A, device 800 displays confirmation interface 860A (e.g., as shown in FIG. 8S and/or overlaid on transfer account interface 820) to authorize the transfer. In some embodiments, as shown in FIG. 8R, in response to detecting tap gesture 838A, device 800 displays message interface 850A (e.g., of a messaging application).

In some embodiments, message interface 850A includes approval 852A (displayed as a transfer message object), which when activated approves (e.g., accepts) a transfer of funds (e.g., $8.50) from the transfer account in accordance with the received request. In some embodiments, approval 852A is displayed inside of a compose bar of the message interface 850A to indicate that the approval has not yet been sent. In some embodiments, approval 852A indicates the amount of funds to be transferred from the transfer account. As shown in FIG. 8S, in response to selection of send affordance 854A (e.g., a tap gesture 856A on send affordance 854A), device 800 displays confirmation interface 860A. In some embodiments, confirmation interface 860A is overlaid on at least a portion of messaging interface 850A.

Confirmation interface 860A includes account indicator 862A, transfer summary 864A, and input instruction 866A. Account indicator 862A identifies the transfer account and, optionally, lists a balance currently associated with the transfer account. In some embodiments, transfer summary 864A provides details of the transfer including the amount of funds to be transferred. Input instruction 866A indicates that the request will be accepted in response to a double press (e.g., “double click”) of button 804. At FIG. 8S, device 800 detects double press input 868A on button 804.

In response to detecting double press input 868A, device 800 approves the request to transfer funds. As shown in FIG. 8T, after accepting the request, device 800 adds the corresponding transfer to transfer history 822 in account summary interface 820 (e.g., as transfer 822d).

FIGS. 8T-8Y illustrate an example in which a user provides a request to transfer funds from the account of another user to the transfer account.

In FIG. 8T, device 800 displays transfer account interface 820. While displaying transfer account interface 820, device 800 detects selection of transfer affordance 826. The selection is a tap gesture 870A on transfer affordance 826. As shown in FIG. 8U, in response to detecting tap gesture 870A, device 800 displays selection interface 830.

As described, selection interface 830 allows a user to select a contact as a recipient of a transfer request. For example, while displaying selection interface 830, device 800 detects selection of contact 832c (e.g., “Sam Jones”) of contacts 832. The selection is a tap gesture 872A on contact 832c. As shown in FIG. 8V, once a contact has been selected, and optionally, confirmed (e.g., by selection of next affordance 836), device 800 displays quantity user interface 840.

While displaying quantity user interface 840, device 800 detects a set of inputs specifying an amount. As shown in FIGS. 8V-8W, device 800 detects, at keypad 842, a set of inputs (e.g., inputs 874A, 876A) specifying an amount of $35.00.

As shown in FIG. 8W, in response to detecting a set of inputs specifying an amount to be transferred, device 800 modifies a visual characteristic of request affordance 844 and pay affordance 846 to indicate request affordance 844 and pay affordance 846 have become selectable. Thereafter, device 800 detects selection of pay affordance 846. In response to selection of request affordance 844 (e.g., a tap gesture 878A on request affordance 844), device 800 initiates a process for requesting transfer of funds from an account of the selected contact (e.g., “Sam Jones”) to the transfer account. For example, as shown in FIG. 8X, in response to detecting selection of request affordance 844, device 800 displays a message interface 860 (e.g., of a messaging application).

In some embodiments, message interface 860 includes request 880A (displayed as a transfer message object), which is a request for transfer of the indicated amount of funds (e.g., $35.00) from the account of the selected contact to the transfer account. In some embodiments, request 880A is displayed inside of a compose bar of the message interface 860 to indicate that the request has not yet been sent to the selected contact. In some embodiments, request 880A indicates the amount specified by the user. In some embodiments, message interface 860 further includes field 868 in which information describing the request (e.g., “team fees”) may be provided. In response to selection of send affordance 864 (e.g., a tap gesture 882A on send affordance 864), device 800 provides the request to the selected contact.

Thereafter, the request is added as a pending request to transfer account interface 820. For example, as shown in FIG. 8Y, transfer account interface 820 includes request 882A corresponding to request to transfer funds from an account of the selected contact (e.g., “Sam Jones”) to the transfer account. In some embodiments, the request 882A indicates a time at which the request expires.

In some embodiments, a user may cancel a request (e.g., that is still pending) after the request has been provided. For example, while displaying transfer account interface 820, device 800 detects selection of request 882A. In some embodiments, the selection is a tap gesture 890A on request 882A. As shown in FIG. 8Z, in response to detecting tap gesture 890A, device 800 displays contact interface 892A.

Contact interface 892A includes transfer history 894A which shows a plurality of recent account activities corresponding to requests to transfer funds between the transfer account and an account of the selected contact (e.g., “Sam Jones”). Contact interface 892A further includes pending requests 896A, which shows pending requests to transfer funds between the transfer account and an account of the selected contact. As shown, pending requests 896A includes request 882A.

While displaying contact interface 892A, device 800 detects selection of request 882A. In some embodiments, the selection is a tap gesture 898A on request 882A. As shown in FIG. 8AA, in response to detecting tap gesture 890A, device 800 displays transfer details interface 800B.

Transfer details interface 800B includes various information about the request 882A, such as the time at which the request was made, the time at which the request expires, and/or the amount specified by the request. Transfer details interface 800B further includes cancel affordance 802B, which when selected, cancels request 882A.

In some instances, a user may provide a request to transfer funds from another user account to the transfer account that is not addressed for a period of time (e.g., 15 days or 30 days). In response, device 800 displays a notification reminding the user that the request has not been addressed. As shown in FIG. 8AB, for example, device 800 displays notification 804B indicating that a previously provided request will expire (or be automatically declined) at a particular date and/or time (e.g., “tomorrow”). In some embodiments, notification 804B indicates that a reminder regarding the request has been provided to the selected contact.

If the request is not accepted within the predetermined period or time, the request expires (or is declined). As shown in FIG. 8AC, after request 882A is declined (e.g., due to expiry) and device 800 adds transfer 822c to transfer history 822. In some embodiments, requests that are not accepted or declined within the predetermined period of time are identified as “expired”. In this example, transfer 822c indicates that the transfer was declined and, optionally, displays the amount of funds to be transferred with a strikethrough, further indicating that the request to transfer was declined and no transfer occurred.

In some instances, a user may resend a request that has expired. For example, while displaying transfer account interface 820, device 800 detects selection of request 822C. The selection is a tap gesture 806B on transfer 822e. As shown in FIG. 8AD, in response to detecting tap gesture 806B, device 800 displays contact interface 892A.

Because the request expired, transfer history 894A of contact interface 82A includes transfer 894Aa, corresponding to the expired request. In response to selection of transfer 894Aa (e.g., tap gesture 810B on transfer 894Aa), device 800 displays transfer details interface 812B.

Transfer details interface 800B includes various information about the expired request 882A, such as the time at which the request was made, the time at which the request expired, and/or the amount specified by the request. Transfer details interface 812B further includes resend affordance 814B, which when selected, resends the request 882A to the selected contact.

FIG. 9 is a flow diagram illustrating a method for initiating a transfer for a user account using an electronic device in accordance with some embodiments. Method 900 is performed at a computer system (e.g., 100, 300, 500, 700, 800) (e.g., a smart watch, a smart phone, and/or a personal computer) that is in communication with a display generation component (e.g., an integrated display and/or a display controller) and one or more input devices (e.g., a touch-sensitive surface (e.g., a touchscreen), a mouse, and/or a keyboard). Some operations in method 900 are, optionally, combined, the orders of some operations are, optionally, changed, and some operations are, optionally, omitted.

As described below, method 900 provides an intuitive way for initiating transactions. The method reduces the cognitive burden on a user for initiating transactions, thereby creating a more efficient human-machine interface. For battery-operated computing devices, enabling a user to initiate transactions faster and more efficiently conserves power and increases the time between battery charges.

The computer system (e.g., 700, 800) concurrently displays (902), via the display generation component (e.g., 702, 802), a portion (e.g., all or less than all) of a first visual representation (e.g., 712a, 812a) corresponding to a first asset account (e.g., a computer storage management account, a transfer account, memory allocation account, a printing allocation account, a transit system account, a payment account, or a store loyalty account) and a portion (e.g., all or less than all) of a second visual representation (e.g., 712b, 812b), different from the first visual representation, corresponding to a second asset account (e.g., a memory allocation account, a printing allocation account, a transit system account, a payment account, or a store loyalty account) that is different from the first asset account. In some embodiments, the portion of the first visual representation and the portion of the second visual representation are displayed as part of an electronic wallet application of the computer system. In some embodiments, the first asset account and the second asset account belong to a user of the computer system and/or are provisioned onto the computer system. In some embodiments, one or more details of the asset accounts are stored in a secure element of the computer system. In some embodiments, a secure element is a hardware component (e.g., a secure microcontroller chip) (e.g., of the computer system) configured to securely store data or an algorithm such that the securely stored data is not accessible by the computer system without proper authentication information from a user of the computer system. Keeping the securely stored data in a secure element that is separate from other storage on the computer system prevents access to the securely stored data even if other storage locations on the computer system are compromised (e.g., by malicious code or other attempts to compromise information stored on the computer system). In some embodiments, the secure element provides (or releases) account information (e.g., an account number and/or a transaction-specific dynamic security code). In some examples, the secure element provides (or releases) the account information in response to the computer system receiving authorization, such as a user authentication (e.g., biometric authentication (e.g., fingerprint authentication; facial authentication; iris authentication; passcode authentication)).

While concurrently displaying the portion of the first visual representation (e.g., 712a, 812a) and the portion of the second visual representation (e.g., 712b, 812b, the computer system receives (904), via the one or more input devices, selection (e.g., 701a, 801a) of (e.g., via a tap input on and/or via a press-and-hold on) the first visual representation corresponding to the first asset account.

In response to receiving selection of the first visual representation corresponding to the first asset account, the computer system displays (906), via the display generation component (e.g., 702, 802), an option (e.g., 726, 826) to initiate a transfer request (e.g., of assets, such as of memory allocation, of print allocation, of transit passes, and/or of funds) using the first asset account (e.g., begin the process to request to make the transfer).

While displaying the option to initiate a transfer request using the first asset account, the computer system receives (908), via the one or more input devices, selection (728, 828) of (e.g., via a tap input on and/or via a press-and-hold on) the option to initiate a transfer request using the first asset account.

In response to receiving selection of the option to initiate a transfer request using the first asset account, the computer system displays (910), via the display generation component, representations (e.g., 732, 732b, 832, 832b) of one or more users (e.g., of one user other than the user of the computer system, of two users other than the user of the computer system, of 10 users other than the user of the computer system, a first representation of a first user and a second representation of a second user, a plurality of representations of a plurality of users). In some embodiments, the representations of the users are displayed as part of a user selection user interface (e.g., of the electronic wallet application of the computer system) for selecting a recipient of a request corresponding to the first asset account.

While displaying the representations of the one or more users, the computer system receives (912), via the one or more input devices, selection (e.g., 734, 834) of a first representation (e.g., 732b, 832b) corresponding to a first user of the one or more users as a recipient of the transfer request using (e.g., a request to receive/accept assets from the first user or a request to send assets to the first user) the first asset account.

In some embodiments, in response to receiving selection of the option to initiate a transfer request using the first asset account, the computer system displays (e.g., overlays on the existing user interface (as a pop-up) and/or rather than displaying representations of one or more users) a plurality of options for initiating the transfer. In some embodiments, the plurality of options for initiating the transfer includes a first option for sending assets and a second option for requesting assets. In some embodiments, the computer system detects selection of the first option or the second option and, in response, displays the representations of one or more users, which can be selected as the recipient of the transfer (e.g., sending if first option was selected or requesting if second option was selected) using the first asset account. Enabling the user to initiating a transfer request after selecting an asset account from a plurality of asset accounts reduces the number of inputs needed to perform the transfer request operation.

In some embodiments, the computer system receives (e.g., instead of or subsequent to selection of a first representation corresponding to a first user) a search input (e.g., a text string and/or an audio input of, for example, a name and/or phone number). The computer system displays (e.g., in response to receiving the search input) one or more representations of one or more searched users based on the search input. The computer system receives selection, via the one or more input devices, of a first representation of a first searched user of the one or more searched users and uses the first searched user as the recipient of the transfer request using the first asset account.

In some embodiments, in response to receiving selection of the first representation corresponding to the first user as the recipient of the transfer request using the first asset account, the computer system displays, via the display generation component, a quantity user interface (e.g., 740, 840) for selection of the quantity of the asset to be transferred based on the transfer request. Displaying a user interface for the user to select a quantity of assets to be transferred enables the user to control the details of the transfer request, thereby improving the machine-human interface.

In some embodiments, the quantity user interface includes an available balance (e.g., 20 MB as shown in FIG. 7E, $20.00 as shown in FIG. 8E) of the first account (e.g., total assets of the first account and/or assets of the first account available for sending). Displaying the available balance enables the user to selects a quantity of the asset for transfer that is less than the available balance without requiring the user to provide additional inputs to find the available balance, thereby reducing the number of required inputs.

In some embodiments, the computer system receives (e.g., while displaying the quantity user interface), via the one or more input devices, user input (e.g., a set of inputs including inputs 748a and 748b, a set of inputs including inputs 848a and 848b) selecting a quantity of the asset to be transferred as part of the transfer request. In some embodiments, subsequent to receiving user input selecting the quantity of the asset, the computer system receives, via the one or more input devices, input (e.g., 750, 850, 878A) (e.g., selection of “request” button specifying that the transfer request is a request for the first user to send the quantity of the asset to the first asset account, selection of a “send” button specifying that the transfer request is a request for the first user to accept transfer of the quantity of the asset from the first asset account, and/or selection of a button that indicates that the quantity has been specified by the user) to proceed with the process for transmitting a request for transfer of the quantity of the asset. In some embodiments, in response to receiving the input to initiate the process for transmitting the request for transfer of the quantity of the asset, the computer system proceeds with the process for transmitting the request for transfer of the quantity of the asset. Proceeding with the process for transmitting the request based on user input provides the user with feedback that the input was received and that the process is proceeding, thereby providing improved feedback to the user.

In some embodiments, proceeding with the process for transmitting the request for transfer of the quantity of the asset includes displaying a draft message (762, 862, 852A and/or comments and information provided in a compose bar of a message interface) (e.g., an instant message a chat message) for a conversation (e.g., a displayed conversation) between the user of the computer system and the first user. In some embodiments, proceeding with the process for transmitting the request for transfer of the quantity of the asset includes transmitting (e.g., in the background and/or without showing a transmitted message as part of a conversion between the user of the computer system and the first user) the request to the first user without displaying a draft message. Displaying a draft message provides the user with feedback that the input was received and that the process is proceeding, thereby providing improved feedback to the user.

In some embodiments, subsequent to (e.g., in response to or after receiving additional required intervening user inputs) receiving selection of the first user as the recipient of the transfer request, the computer system transmits, to the first user, the transfer request using (e.g., a request to receive/accept assets from or a request to send assets to) the first asset account. In some embodiments, the transfer request is transmitted in response to receiving user input to send the draft message in the conversation. In some embodiments, the transfer request is transmitted in response to receiving the input to initiate the process for transmitting the request for transfer of the quantity of the asset.

In some embodiments, subsequent to transmitting, to the first user, the transfer request using the first asset account, the computer system receives an update on the status of the transfer request. In some embodiments, the computer system displays, via the display generation component, a transfer history (e.g., 722, 822) that includes a plurality of transfers (e.g., 722a-722c, 822a-822e) using the first account, including: in accordance with a determination that the update on the status of the transfer request indicates that the first user has declined the transfer request, displaying an indication (e.g., as indicated in transfer 822e in FIGS. 8AC-8AD) that the transfer request has been declined. In some embodiments, in accordance with a determination that the update on the status of the transfer request indicates that the first user has accepted the transfer request, displaying an indication (e.g., as indicated in transfer 722c, 822c) that the transfer request has been accepted. In some embodiments, in accordance with a determination that the update on the status of the transfer request indicates that the transfer request has expired, displaying an indication that the transfer request has expired (e.g., as indicated in transfer 822e in FIGS. 8AC-8AD). Displaying an indication that the transfer request has been declined provides the user with visual feedback about the state of the computer system and, in particular, the state of the transfer request.

In some embodiments, while displaying the indication that the transfer request has been declined, the computer system detects, via the one or more input devices, one or more inputs that include selection (e.g., 806B) of the indication that the transfer has been declined (e.g., a tap on the indication that the transfer has been declined to display information about the transfer and a subsequent tap on the transfer while displaying information about the transfer). In some embodiments, in response to receiving the one or more inputs that include selection of the indication that the transfer has been declined, the computer system displays an option (e.g., 814B) to re-request the transfer (e.g., using the same quantity of assets, using the same first account, to be sent to the same first user). In some embodiments, the computer system receives, via the one or more input devices, selection of the option to re-request the transfer. In some embodiments, in response to receiving selection of the option to re-request the transfer, the computer system initiates a process to transmit a request to the first user for transfer of the quantity of the asset using the first account. Providing the user with an option to re-request the transfer enables the user to quickly initiate another request (e.g., without needing to re-enter the quantity and/or recipient of the request), thereby reducing the number of inputs required to perform the operation.

In some embodiments, subsequent to transmitting, to the first user, the transfer request using the first asset account, the computer system concurrently displays, via the display generation component: an indication (e.g., as indicated in transfer 722c or transfer 822c) that the transfer request is pending (e.g., prior to the first user having accepted/declined the transfer request); and an option (e.g., 726, 826) to initiate a second transfer request (e.g., of assets, such as of memory allocation, of print allocation, of transit passes, and/or of funds), different from the transfer request, using the first asset account (e.g., to be sent to the first user, to the second user, and/or to another user). In some embodiments, the computer system also optionally concurrently displays, with the indication that the transfer request is pending and the option to initiate a second transfer request, the first visual representation corresponding to the first asset account and/or one or more transfers performed using the first asset account (e.g., other requests to send/receive assets using the first asset account, such as to the first user, a second user, and/or other users). In some embodiments, the transfer request that is pending (e.g., has not yet been accepted, been declined, or expired) is displayed above (e.g., in a list format) transactions that were completed after the transfer request was transmitted (e.g., transfer 722c is displayed above transfers 722a and 722b, transfer 822c is displayed above transfers 822a and 822b). Displaying an indication that the transfer request is pending provides the user with visual feedback about the status of the transfer request, thereby providing the user with improved visual feedback.

In some embodiments, while displaying the indication that the transfer request is pending, the computer system receives, via the one or more user inputs, selection (e.g., 890A, 898A) of (e.g., tap input on and/or swipe gesture on) the indication that the transfer request is pending. In some embodiments, in response to receiving selection of the indication that the transfer request is pending, the computer system displays, via the display generation component, information (e.g., pending requests and transfer history 894A in FIG. 8Z) about the first user (since the transfer request was transmitted to the first user) including: information about the transfer request; and information about a plurality of transfers (e.g., completed, accepted, declined, and/or expired) of assets with the first user (e.g., previous transfers (sent and/or received) using the first asset account and/or other asset accounts), wherein information about the transfer request is displayed above information about the plurality of transfers of assets with the first user. In some embodiments, details of the first user includes a transaction history for pending and completed transfers with the first user, such as using the first asset account and/or other asset accounts and include the pending transfer request. In some embodiments, the information about the first user are displayed without displaying transaction information for the second user (or other users). The computer system to display a plurality of transfers of assets corresponding with the first user enables the user of the computer system to quickly see what the transfer history has been with the first user without needing to scroll through a list of transactions from multiple users, thereby providing the user with improved visual feedback (e.g., concise feedback) and reducing the number of user inputs required to review the transfer history.

In some embodiments, the computer system receives, via the one or more input devices, selection (e.g., 898A) of the information about the transfer request. In some embodiments, in response to receiving selection of the information about the transfer request, the computer system displays, via the display generation component, a transactions details user interface (e.g., 800B) for the transfer request, including: expiration information (e.g., number of days until expiration and/or date of expiration) for the transfer request; and a cancellation option (e.g., 802B) that, when activated, initiates a process to cancel the transfer request (e.g., so that the first user can no longer accept/decline the transfer). In some embodiments, the computer system receives selection of the cancellation option and cancels the transfer request. In some embodiments, the computer system receives selection of the cancellation option and requires the user to confirm the selection before proceeding to cancel the transfer request. In some embodiments, the transaction details user interface further concurrently includes display of: status (e.g., pending, declined, accepted, expired) of the transfer request, name of recipient (e.g., name of the first user), expiration information of the transfer request, transfer amount of the transfer request, and/or an option to cancel transfer request. Displaying expiration information and a cancellation option together enables the user to know how long before the request expires and to cancel the transfer request if it is no longer desired, thereby reducing the number of inputs required to perform the operation.

In some embodiments, the computer system displays (e.g., on a lock screen and/or as part of a user interface of the electronic wallet application), via the display generation component, a notification (e.g., 814A, 820A) with expiration information (e.g., number of days until expiration and/or date of expiration) for the transfer request. In some embodiments, the notification indicates that the transfer request is expiring the following day. In some embodiments, the notification indicates that the transfer request is expiring the following week. In some embodiments, the computer system receives, via the one or more input devices, selection of (e.g., 816A, 822A) (e.g., tap input on and/or swipe input on) the notification with expiration information. In some embodiments, in response to receiving selection of the notification, the computer system displays, via the display generation component, a transactions details user interface (e.g., 800B) for the transfer request. In some embodiments, the transactions details user interface for the transfer request includes: expiration information (e.g., number of days until expiration and/or date of expiration) for the transfer request; and a cancellation option (e.g., 802B) that, when activated, initiates a process to cancel the transfer request (e.g., so that the first user can no longer accept/decline the transfer). In some embodiments, the computer system receives selection of the cancellation option and cancels the transfer request. In some embodiments, the computer system receives selection of the cancellation option and requires the user to confirm the selection before proceeding to cancel the transfer request. In some embodiments, the notification with expiration information is a notification that the recipient (the first user) was reminded (e.g., via a notification on a computer system of the first user) of the transfer request (and, optionally, of when the transfer request expires). Providing the user with a notification with expiration information for the transfer request provides the user with feedback about the state of the transfer request (e.g., how long before the request expires), thereby providing improved visual feedback.

In some embodiments, after assets have been added to the first asset account (e.g., via a second transfer request, from the first user, and/or from the second user): the computer system displays (e.g., on a lock screen of the computer system), via the display generation component, a first notification (e.g., 884) that assets (and, optionally, the amount of assets) have been added to the first asset account. Providing the user with a notification that assets have been added to an asset account provides the user with visual feedback about the state of the asset account and computer system, thereby providing improved visual feedback.

In some embodiments, after assets have been added to the first asset account (e.g., via a second transfer request, from the first user, and/or from the second user): the computer system displays (e.g., on a lock screen of the computer system, before or after displaying the first notification that assets have been added to the first account), via the display generation component, a second notification (e.g., 886) (e.g., concurrently with the first notification) including an indication of (e.g., a numerical value) an amount of assets (e.g., a balance, an amount of available assets) of the first asset account. Providing the user with a notification of the balance of the asset account provides the user with visual feedback about the state of the asset account and computer system, thereby providing improved visual feedback.

In some embodiments, in response to receiving selection of the first visual representation corresponding to the first asset account, the computer system displays, via the display generation component and concurrently with the option to initiate a transfer request (e.g., of assets, such as of memory allocation, of print allocation, of transit passes, and/or of funds) using the first asset account, the first visual representation (e.g., 712a, 812a) (e.g., a visual representation of a card of an account, such as a memory account, a bank account, and/or a cash account) and a (e.g. complete or less than complete) transfer history (e.g., 722, 822) of one or more (e.g., of one, of two, of 10, of a plurality of) transfers performed using the first asset account (e.g., without displaying the second visual representation and/or without displaying a transfer history for the second asset account). Displaying the first visual representation along with a transfer history for the first asset account provides the user with visual feedback about the account with which the user is interacting and the history of the account, thereby providing the user with improved visual feedback.

In some embodiments, in response to receiving selection of the first visual representation corresponding to the first asset account, the computer system displays, via the display generation component and concurrently with the option to initiate a transfer request (e.g., of assets, such as of memory allocation, of print allocation, of transit passes, and/or of funds) using the first asset account and a (e.g. complete or less than complete) transfer history of one or more (e.g., of one, of two, of 10, of a plurality of transfers performed using the first asset account, a filter option (e.g., 724, 824) for filtering the transfer history of the first asset account.

In some embodiments, in response to receiving selection of the filter option, the computer system displays one or more (e.g., some or all) of the following options (e.g., 890a-890f) for filter: all transfer, requested transfers, paid transfers, transfer to the account based on amounts paid (e.g., cash back), pending transfer requests, and purchases. Selection of an option for filtering causes the computer system to limit the transfer history to the selected type of transfer.

In some embodiments, in response to receiving selection of the first visual representation corresponding to the first asset account, the computer system displays, via the display generation component and concurrently with the option to initiate a transfer request, a search option (e.g., 894). In response to receiving selection (e.g., 896) of the search option, concurrently displaying a search field and one or more options (e.g., 802A, 804A, 806A) for filtering (e.g., all transfer, requested transfers, paid transfers, transfer to the account based on amounts paid (e.g., cash back), pending transfer requests, and purchases; where selection of an option for filtering causes the computer system to limit the search results (and/or transfer history) to the selected type of transfer).

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

As described above, one aspect of the present technology is the gathering and use of data available from various sources to improve transfers. The present disclosure contemplates that in some instances, this gathered data may include personal information data that uniquely identifies or can be used to contact or locate a specific person. Such personal information data can include demographic data, location-based data, telephone numbers, email addresses, twitter IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to prevent inadvertent transfers of assets to unintended recipients. Further, other uses for personal information data that benefit the user are also contemplated by the present disclosure.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of transfer services, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, transfers can be performed using a bare minimum amount of personal information or publicly available information.

What is claimed is:

1. A computer system configured to communicate with a display generation component and one or more input devices, comprising:
one or more processors; and
memory storing one or more programs configured to be executed by the one or more processors, the one or more programs including instructions for:
concurrently displaying, via the display generation component, a portion of a first visual representation corresponding to a first asset account and a portion of a second visual representation, different from the first visual representation, corresponding to a second asset account that is different from the first asset account;
while concurrently displaying the portion of the first visual representation and the portion of the second visual representation, receiving, via the one or more input devices, selection of the first visual representation corresponding to the first asset account;
in response to receiving selection of the first visual representation corresponding to the first asset account, displaying, via the display generation component, an option to initiate a transfer request using the first asset account;
while displaying the option to initiate a transfer request using the first asset account, receiving, via the one or more input devices, selection of the option to initiate a transfer request using the first asset account; and
in response to receiving selection of the option to initiate a transfer request using the first asset account, displaying, via the display generation component, representations of one or more users; and while displaying the representations of the one or more users, receiving, via the one or more input devices, selection of a first representation corresponding to a first user of the one or more users as a recipient of the transfer request using the first asset account.

2. The computer system of claim 1, the one or more programs further including instructions for:
in response to receiving selection of the first representation corresponding to the first user as the recipient of the transfer request using the first asset account, displaying, via the display generation component, a quantity user interface for selection of the quantity of the asset to be transferred based on the transfer request.

3. The computer system of claim 2, wherein the quantity user interface includes an available balance of the first account.

4. The computer system of claim 2, the one or more programs further including instructions for:
receiving, via the one or more input devices, user input selecting a quantity of the asset to be transferred as part of the transfer request;
subsequent to receiving user input selecting the quantity of the asset, receiving, via the one or more input devices, input to proceed with the process for transmitting a request for transfer of the quantity of the asset; and
in response to receiving the input to initiate the process for transmitting the request for transfer of the quantity of the asset, proceeding with the process for transmitting the request for transfer of the quantity of the asset.

5. The computer system of claim 4, wherein proceeding with the process for transmitting the request for transfer of the quantity of the asset includes displaying a draft message for a conversation between the user of the computer system and the first user.

6. The computer system of claim 1, the one or more programs further including instructions for:
subsequent to receiving selection of the first user as the recipient of the transfer request, transmitting, to the first user, the transfer request using the first asset account.

7. The computer system of claim 6, the one or more programs further including instructions for:
subsequent to transmitting, to the first user, the transfer request using the first asset account, receiving an update on the status of the transfer request; and
displaying, via the display generation component, a transfer history that includes a plurality of transfers using the first account, including:
in accordance with a determination that the update on the status of the transfer request indicates that the first user has declined the transfer request, displaying an indication that the transfer request has been declined.

8. The computer system of claim 7, the one or more programs further including instructions for:
while displaying the indication that the transfer request has been declined, detecting, via the one or more input devices, one or more inputs that include selection of the indication that the transfer has been declined;
in response to receiving the one or more inputs that include selection of the indication that the transfer has been declined, displaying an option to re-request the transfer;
receiving, via the one or more input devices, selection of the option to re-request the transfer; and
in response to receiving selection of the option to re-request the transfer, initiating a process to transmit a request to the first user for transfer of the quantity of the asset using the first account.

9. The computer system of claim 1, the one or more programs further including instructions for:
subsequent to transmitting, to the first user, the transfer request using the first asset account, concurrently displaying, via the display generation component:
an indication that the transfer request is pending; and
an option to initiate a second transfer request, different from the transfer request, using the first asset account.

10. The computer system of claim 9, the one or more programs further including instructions for:
while displaying the indication that the transfer request is pending, receiving, via the one or more user inputs, selection of the indication that the transfer request is pending; and
in response to receiving selection of the indication that the transfer request is pending, displaying, via the display generation component, information about the first user including:
information about the transfer request; and
information about a plurality of transfers of assets with the first user, wherein information about the transfer request is displayed above information about the plurality of transfers of assets with the first user.

11. The computer system of claim 10, the one or more programs further including instructions for:
receiving, via the one or more input devices, selection of the information about the transfer request; and
in response to receiving selection of the information about the transfer request, displaying, via the display generation component, a transactions details user interface for the transfer request, including:
expiration information for the transfer request; and
a cancellation option that, when activated, initiates a process to cancel the transfer request.

12. The computer system of claim 1, the one or more programs further including instructions for:
displaying, via the display generation component, a notification with expiration information for the transfer request;
receiving, via the one or more input devices, selection of the notification with expiration information; and
in response to receiving selection of the notification, displaying, via the display generation component, a transactions details user interface for the transfer request.

13. The computer system of claim 1, the one or more programs further including instructions for:
after assets have been added to the first asset account:
displaying, via the display generation component, a first notification that assets have been added to the first asset account.

14. The computer system of claim 1, the one or more programs further including instructions for:
after assets have been added to the first asset account:
displaying, via the display generation component, a second notification including an indication of an amount of assets of the first asset account.

15. The computer system of claim 1, the one or more programs further including instructions for:
in response to receiving selection of the first visual representation corresponding to the first asset account, displaying, via the display generation component and concurrently with the option to initiate a transfer request using the first asset account, the first visual representation and a transfer history of one or more transfers performed using the first asset account.

16. A non-transitory computer-readable storage medium storing one or more programs configured to be executed by one or more processors of a computer system that is configured to communicate with a display generation component and one or more input devices, the one or more programs including instructions for:
concurrently displaying, via the display generation component, a portion of a first visual representation corresponding to a first asset account and a portion of a second visual representation, different from the first visual representation, corresponding to a second asset account that is different from the first asset account;
while concurrently displaying the portion of the first visual representation and the portion of the second visual representation, receiving, via the one or more input devices, selection of the first visual representation corresponding to the first asset account;
in response to receiving selection of the first visual representation corresponding to the first asset account, displaying, via the display generation component, an option to initiate a transfer request using the first asset account;
while displaying the option to initiate a transfer request using the first asset account, receiving, via the one or more input devices, selection of the option to initiate a transfer request using the first asset account; and
in response to receiving selection of the option to initiate a transfer request using the first asset account, displaying, via the display generation component, representations of one or more users; and while displaying the representations of the one or more users, receiving, via the one or more input devices, selection of a first representation corresponding to a first user of the one or more users as a recipient of the transfer request using the first asset account.

17. A method, comprising:
at a computer system that is in communication with a display generation component and one or more input devices:
concurrently displaying, via the display generation component, a portion of a first visual representation corresponding to a first asset account and a portion of a second visual representation, different from the first visual representation, corresponding to a second asset account that is different from the first asset account;
while concurrently displaying the portion of the first visual representation and the portion of the second visual representation, receiving, via the one or more input devices, selection of the first visual representation corresponding to the first asset account;
in response to receiving selection of the first visual representation corresponding to the first asset account, displaying, via the display generation component, an option to initiate a transfer request using the first asset account;
while displaying the option to initiate a transfer request using the first asset account, receiving, via the one or more input devices, selection of the option to initiate a transfer request using the first asset account; and
in response to receiving selection of the option to initiate a transfer request using the first asset account, displaying, via the display generation component, representations of one or more users; and while displaying the representations of the one or more users, receiving, via the one or more input devices, selection of a first representation corresponding to a first user of the one or more users as a recipient of the transfer request using the first asset account.
